(19) United States
(12) Patent Application Publication
(10) Pub. No.: US 2026/0255189 A1
(43) Pub. Date: Aug. 27, 2026

(54) WIRELESS COMMUNICATION SYSTEM, WIRELESS RELAY STATION MONITORING CONTROL DEVICE AND WIRELESS COMMUNICATION METHOD

(71) Applicant: NTT, Inc., Tokyo (JP)

(72) Inventors: Akira MATSUSHITA, Musashino-shi, Tokyo (JP); Koichi HARADA, Musashino-shi, Tokyo (JP); Junichi ABE, Musashino-shi, Tokyo (JP); Fumihiro YAMASHITA, Musashino-shi, Tokyo (JP); Takeshi ONIZAWA, Musashino-shi, Tokyo (JP)

(73) Assignee: NTT, Inc., Tokyo (JP)

(21) Appl. No.: 18/879,254

(22) PCT Filed: Jul. 11, 2022
(86) PCT No.: PCT/JP2022/027261

§ 371 Date: Dec. 27, 2024

(51) Int. Cl. H04W 24/08; H04B 17/373; H04W 64/00; H04W 84/06

(52) U.S. Cl. CPC H04W 24/08; H04B 17/373; H04W 64/00; H04W 84/06

(57) ABSTRACT

The wireless communication system includes a wireless relay station staying in the air, a ground station for transmitting and receiving radio waves to and from the wireless relay station, and a wireless relay station monitoring control device. The wireless relay station monitoring control device calculates a prediction value of a rainfall attenuation amount of the feeder link at a movement candidate position in a radio relay area of the wireless relay station and a current position on the basis of weather prediction information. Further, the communication quality of the feeder link at the movement candidate position and the current position is predicted based on the prediction value. Further, a position at which attenuation of the feeder link is predicted to be less than that at which the wireless relay station stays at the current position is selected from the movement candidate positions on the basis of the communication quality.

### TECHNICAL FIELD

The present disclosure relates to a wireless communication system, a wireless relay station monitoring control device, and a wireless communication method.

### BACKGROUND ART

A non-terrestrial network (NTN) has attracted attention as an integrated infrastructure in which a high altitude platform station (HAPS), a low earth orbit (LEO) in a space, and a geostationary orbit (GEO) are also included in a field of view (see, for example, Non Patent Literature 1). A technique of using a HAPS or the like that can remain in the air as a wireless relay station for radio waves is known (for example, see Patent Literature 1).

A communication line in the HAPS includes a feeder link between a HAPS staying in the air and an HAPS ground station present in a ground communication network, and a service link between the HAPS and a terminal device. The HAPS is located at about 20 km in height, and a radius of a ground area is about 50 km. Furthermore, while the HAPS service link is expected to be able to use a frequency of 2 GHz, the use of millimeter waves in a higher frequency band (for example, the 38 GHz band) is being considered for the feeder link. However, it is known that deterioration in communication quality due to rainfall cannot be avoided in a frequency band in a millimeter wave region. Therefore, a rainfall attenuation compensation scheme has been studied in which a plurality of HAPS ground stations are installed in an HAPS area and a feeder link is switched to another HAPS ground station by using a line disconnection or the like due to rainfall as a trigger (see, for example, Non Patent Literature 2).

According to the technology disclosed in Non Patent Literature 2, it is possible to avoid service interruption even when a rain area is applied between the HAPS and the HAPS ground stations, and to realize the improvement of a line operation rate, by selecting the HAPS ground station from a plurality of HAPS ground stations.

For a rain cloud which may have an influence on communication in a millimeter wave region, a view is provided by the Japan weather Association (see, for example, Non Patent Literature 3).

For prediction of rainfall, precipitation intensity prediction is performed for every 250 m mesh or every 1 km mesh in the whole country of Japan using high resolution precipitation nowcast data provided from the Meteorological Agency (for example, see Non Patent Literature 4).

Frequency (GHz) characteristics of rainfall attenuation (dB/km) are shown in CCIR, Rep. 721-3, FIG. 1 (for example, see Non Patent Literature 5).

### CITATION LIST

### Patent Literature

Patent Literature 1: U.S. Patent Application Publication No. 2016/0046387

### Non Patent Literature

Non Patent Literature 1: Yamashita, “R&D on IOWN Space Sensing and/or Radio Access Networks”, SAT2021-29.
Non Patent Literature 2: Kitanozono, Suzuki, Kishiyama, Sotozono, Toyama, Ouchi, Miura, Tsuji, “Development of HAPS Backhaul System using mm Wave Frequency—HAPS as a NTN System for 5G and Beyond—”, SAT2021-30.
Non Patent Literature 3: Japan Weather Association Ten Types of Clouds: There are 10 types of clouds, and distinguishing method is explained from shape or height!—Middle cloud edition—https://tenki.jp/suppl/tenkijp_labo/2021/07/31/30531.html
Non Patent Literature 4: Japan Meteorological Agency High-resolution precipitation nowcast https://www.jma.go.jp/jma/kishou/know/kurashi/highres_nowcast.html
Non Patent Literature 5: CCIR “ATTENUATION BY HYDROMETEORS, IN PARTICULAR PRECIPITATION, AND OTHER ATMOSPHERIC PARTICLES (frequency (GHz) characteristics of rainfall attenuation (dB/km))”, Rep. 721-3, (1990).

### SUMMARY OF THE INVENTION

### Technical Problem

In the related art, in order to avoid a rain area between the HAPS and the HAPS ground station, such HAPS ground station as to avoid the rain area is selected from among a plurality of HAPS ground stations. However, in a case in which only one HAPS ground station is present, this method cannot be applied, and line quality is likely to deteriorate and the service is likely to be interrupted.

In order to solve the above problem, a first object of the present disclosure is to provide a wireless communication system capable of securing communication quality and improving an operation rate of an NTN even when there is an influence of rainfall in a feeder link of the NTN.

Further, a second object of the present disclosure is to provide a wireless relay station monitoring control device capable of securing communication quality and improving an operation rate of an NTN even when there is an influence of rainfall in a feeder link of the NTN.

Further, a third object of the present disclosure is to provide a wireless communication method capable of securing communication quality and improving an operation rate of an NTN even when there is an influence of rainfall in a feeder link of the NTN.

### Solution to Problem

A first aspect of the present disclosure is a wireless communication system that performs communication using a non-terrestrial network, the wireless communication system including:
a wireless relay station configured to stay in the air and relay wireless communication;
a ground station configured to perform transmission and reception of radio waves to and from the wireless relay station and connect the wireless communication of the non-terrestrial network to a terrestrial network; and
a wireless relay station monitoring control device configured to monitor and control the wireless relay station and the ground station via the terrestrial network, wherein the wireless relay station monitoring control device is preferably configured to execute
rainfall attenuation amount prediction value calculation processing for calculating a prediction value of a rainfall attenuation amount of the radio wave at a movement candidate position in a radio relay area of the wireless relay station and a current position on the basis of weather prediction information,
communication quality prediction processing for predicting communication quality due to the radio wave at the movement candidate position and the current position of the wireless relay station on the basis of the prediction value,
movement position selection processing for selecting a position at which attenuation of the radio wave is predicted to be less than that in which the wireless relay station stays at a current position from among the movement candidate positions on the basis of the communication quality, and
movement processing for moving the wireless relay station to the position selected by the movement position selection processing.

Further, a second aspect is a wireless relay station monitoring control device for monitoring and controlling a wireless relay station staying in the air in a non-terrestrial network, wherein the wireless relay station monitoring control device is configured to execute:
rainfall attenuation amount prediction value calculation processing for calculating a prediction value of a rainfall attenuation amount at a movement candidate position and a current position in a radio relay area of the wireless relay station on the basis of weather prediction information, for a radio wave transmitted and received between the wireless relay station and a ground station,
communication quality prediction processing for predicting communication quality due to the radio wave at the movement candidate position and the current position of the wireless relay station on the basis of the prediction value,
movement position selection processing for selecting a position at which attenuation of the radio wave is predicted to be less than that in which the wireless relay station stays at a current position from among the movement candidate positions on the basis of the communication quality, and
movement processing for moving the wireless relay station to the position selected by the movement position selection processing.

Further, a third aspect is a wireless communication method for performing communication using a non-terrestrial network, wherein
a wireless relay station staying in the air relays wireless communication in an area,
a ground station configured to transmit and receive radio waves to and from the wireless relay station connects wireless communication of the non-terrestrial network to a terrestrial network, and
the wireless relay station monitoring control device for monitoring and controlling the wireless relay station and the ground station via the terrestrial network executes
rainfall attenuation amount prediction value calculation processing for calculating a prediction value of a rainfall attenuation amount of the radio wave at a movement candidate position in a radio relay area of the wireless relay station and a current position on the basis of weather prediction information,
communication quality prediction processing for predicting communication quality due to the radio wave at the movement candidate position and the current position of the wireless relay station on the basis of the prediction value,
movement position selection processing for selecting a position at which attenuation of the radio wave is predicted to be less than that in which the wireless relay station stays at a current position from among the movement candidate positions on the basis of the communication quality, and
movement processing for moving the wireless relay station to the position selected by the movement position selection processing.

### Advantageous Effects of Invention

According to the first to third aspects of the present disclosure, it is possible to provide a wireless communication system, a wireless relay station monitoring control device, and a wireless communication method capable of securing communication quality and improving an operation rate of an NTN even when there is an influence of rainfall in a feeder link of the NTN.

### BRIEF DESCRIPTION OF DRAWINGS

FIG. 1 is a diagram illustrating a configuration of a wireless communication system of the related art using a non-terrestrial network;

FIG. 2 is a diagram illustrating a state in which a rain area is applied between the HAPS and the HAPS ground station currently in use in the wireless communication system of the related art;

FIG. 3 is a diagram illustrating a state in which the rain area is applied between the HAPS and the HAPS ground station currently in use, and a feeder link is switched to the other HAPS ground station in the wireless communication system of the related art;

FIG. 4 is a flowchart of processing for switching the feeder link to the other HAPS ground station when the rain area is applied between the HAPS and the HAPS ground station currently in use in the wireless communication system of the related art;

FIG. 5 is a diagram illustrating a state in which the rain area is applied between the HAPS and the HAPS ground station when only one HAPS ground station is present in the wireless communication system of the related art;

FIG. 6 is a flowchart illustrating a case in which only one HAPS ground station is present in the wireless communication system of the related art;

FIG. 7 is a diagram illustrating a state in which the rain area approaches between the HAPS and the HAPS ground station in a wireless communication system according to Embodiment 1 of the present disclosure;

FIG. 8 is a diagram illustrating a state in which the HAPS moves within a movement possibility range before the rain area is applied between the HAPS and the HAPS ground station in the wireless communication system according to Embodiment 1 of the present disclosure;

FIG. 9 illustrates a list of parameters used in the position movement processing (step 232) of the HAPS performed by the HAPS monitoring and control station according to Embodiment 1 of the present disclosure;

FIG. 10 is a flowchart of position movement processing (step 232) of the HAPS performed by the HAPS monitoring and control station according to Embodiment 1 of the present disclosure;

FIG. 11 illustrates a parameter used in rainfall attenuation amount prediction value calculation processing in step 142;

FIG. 12 is a flowchart illustrating details of the rainfall attenuation amount prediction value calculation processing in step 142;

FIG. 13 is a diagram illustrating the type and height of the cloud provided by Non Patent Literature 3;

FIG. 14 illustrates an example of precipitation intensity prediction on the basis of high resolution precipitation nowcast data provided from the Meteorological Agency;

FIG. 15 is a diagram illustrating an extraction principle of a set of high resolution precipitation nowcast meshes in step 162;

FIG. 16 is a diagram illustrating details of a method of converting the precipitation intensity prediction value into a rainfall attenuation coefficient in step 164;

FIG. 17 illustrates a result of conversion of the precipitation intensity prediction value into a rainfall attenuation coefficient prediction value;

FIG. 18 is a diagram illustrating details of a method of calculating a propagation distance of a feeder link 111 for each mesh in step 165;

FIG. 19 illustrates an example of a result of calculation the rainfall attenuation amount prediction value of meshes 7 to 9;

FIG. 20 illustrates parameters used in the communication quality prediction processing in step 144;

FIG. 21 is a flowchart illustrating details of the communication quality prediction processing in step 144;

FIG. 22 illustrates parameters used in the movement determination processing in step 146;

FIG. 23 is a flowchart illustrating details of the movement determination processing in step 146;

FIG. 24 illustrates parameters used in movement position selection processing in step 150;

FIG. 25 is a flowchart illustrating details of the movement position selection processing in step 150;

FIG. 26 is a flowchart illustrating details of the post-movement parameter update processing in step 154;

FIG. 27 is a diagram illustrating a calculation principle for a propagation loss correction amount calculated in the propagation loss correction amount calculation processing in step 213;

FIG. 28 illustrates an example of the result of calculation of the propagation loss correction amount;

FIG. 29 illustrates parameters used in the propagation loss correction amount calculation processing in step 213;

FIG. 30 is a flowchart illustrating details of the propagation loss correction amount calculation processing in step 213;

FIG. 31 is a diagram illustrating a state in which the rain area approaches between the HAPS and the HAPS ground station in a wireless communication system according to Embodiment 2 of the present disclosure;

FIG. 32 is a diagram illustrating a state in which the HAPS moves to another movement possibility position before the rain area is applied between the HAPS and the HAPS ground station in the wireless communication system according to Embodiment 2 of the present disclosure;

FIG. 33 is a diagram illustrating a state in which the rain area approaches between the HAPS and the HAPS ground station in a wireless communication system according to Embodiment 3 of the present disclosure;

FIG. 34 is a diagram illustrating a state in which the HAPS moves within a movement possibility range corresponding to the current position before the rain area is applied between the HAPS and the HAPS ground station in the wireless communication system according to Embodiment 3 of the present disclosure;

FIG. 35 is a diagram illustrating a newly determined movement possibility range according to the position after the HAPS moves in the wireless communication system according to Embodiment 3 of the present disclosure;

FIG. 36 is a flowchart illustrating details of the post-movement parameter update processing in step 154 according to Embodiment 3 of the present disclosure;

FIG. 37 is a diagram showing a configuration of one cell according to Embodiment 4 of the present disclosure; and

FIG. 38 is a diagram illustrating a configuration of a wireless communication system according to Embodiment 4 of the present disclosure.

### DESCRIPTION OF EMBODIMENTS

### Comparative Example

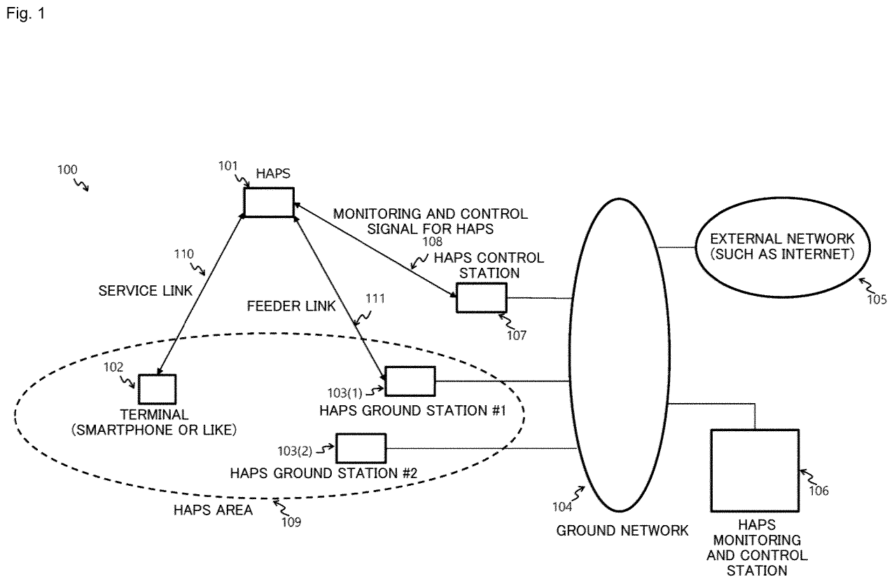

First, the related art will be described as a comparative example. FIG. 1 is a diagram illustrating a configuration of a wireless communication system of the related art using a non-terrestrial network. In a wireless communication system 100 of the related art, an HAPS 101 is a wireless relay station which stays in the air and relays radio waves, traffic, and the like. The radio waves relayed by the HAPS 101 are a data signal such as Internet traffic transmitted and received by a terminal 102.

The terminal 102 is a user terminal such as a smartphone.

The two HAPS ground stations 103(1) and 103(2) serve as gateways for connecting traffic between the terminal 102 and the HAPS 101 and traffic between the HAPS 101 and the HAPS ground station 103 to a terrestrial network 104.

The terrestrial network 104 is a part corresponding to a core network in an existing cellular phone network, and is a network based on a ground line including a transmission line such as an optical fiber and a router, a switch, or the like.

An external network 105 is a network connected to the terrestrial network 104, and generally refers to the Internet.

The HAPS monitoring and control station 106 has a function of remotely monitoring and controlling the HAPS 101 and the HAPS ground station 103 via the terrestrial network 104.

The HAPS control station 107 has a function of converting a signal for controlling the HAPS 101 issued from the HAPS monitoring and control station 106 into a radio channel.

The monitoring and control signal 108 is a signal for monitoring and control to the HAPS 101. In the transmission and reception of the monitoring and control signal 108, an independent dedicated radio channel different from a radio channel used for the transmission and reception of traffic between the terminal 102 and the HAPS 101 and the traffic between the HAPS 101 and the HAPS ground station 103 is used.

The HAPS area 109 is a radio relay area of the HAPS 101. The HAPS area 109 is in phase with a cell called a cellular phone base station, and the terminal 102 receives a service of the Internet communication within an HAPS area range. In the example illustrated in FIG. 1, the HAPS area 109 draws a circle centering on the HAPS 101, but even when the HAPS area 109 stays at a position shifted in a horizontal direction from above a center of the circle, the HAPS area 109 can be formed into a circular shape by an antenna technology mounted on the HAPS 101. Further, it is possible to perform control such as removing a place in which traffic cannot be expected from the area, and strengthening radio waves to a specific area.

A service link 110 is a wireless communication between the HAPS 101 and the terminal 102, and corresponds to a part between the terminal 102 and a mobile phone base station in the case of an existing mobile phone network. In order to use a mobile phone base station in place of the HAPS 101, the service link 110 is assumed to use the same frequency band (2 GHz band or the like) as that of the mobile phone. This frequency band is a frequency in which there is hardly any attenuation of radio waves due to rainfall. The traffic of the service link 110 is the Internet traffic transmitted and received by the terminal 102.

The feeder link 111 is a wireless communication between the HAPS 101 and the HAPS ground station 103. A frequency band used by the feeder link 111 is assumed to be a millimeter wave frequency (38 GHz band or the like), unlike the service link 110. It is generally known that the attenuation of radio waves due to rainfall becomes remarkable at a frequency of 10 GHz or more. Therefore, the feeder link 111 must assume an event such as deterioration of communication quality due to rainfall or communication disconnection. The traffic of the service link 110 is relayed to the feeder link 111 by the HAPS 101. Therefore, the traffic of the feeder link 111 is the Internet traffic transmitted and received by the terminal 102 similarly to the service link 110.

In the example illustrated in FIG. 1, the wireless relay station in the NTN is the HAPS 101, but the same applies to a drone or the like.

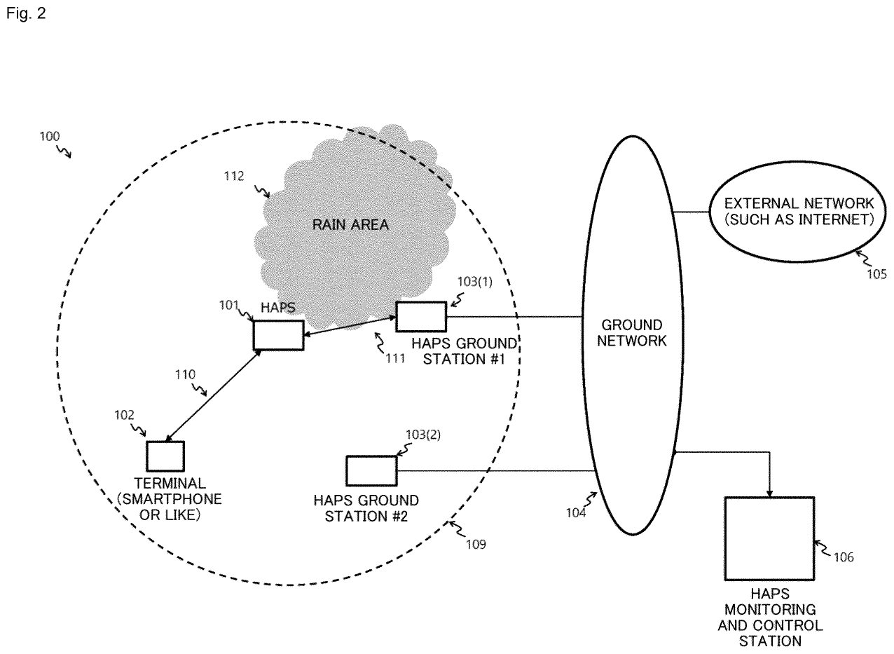

FIG. 2 is a diagram illustrating a state in which a rain area is applied between the HAPS and the HAPS ground station currently in use in the wireless communication system of the related art. A rain area 112 is applied to a feeder link 111 between the HAPS 101 and the HAPS ground station 103(1).

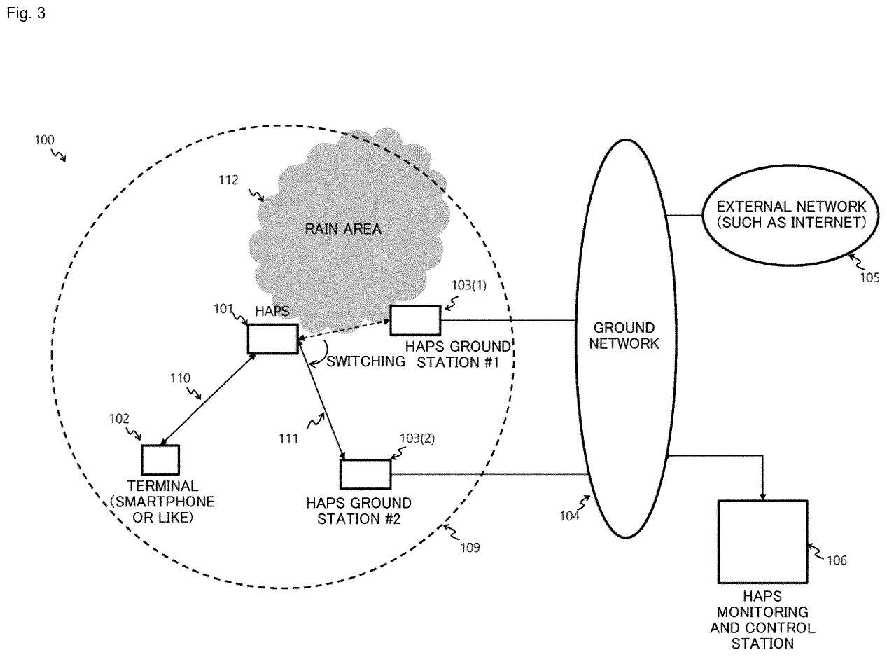

FIG. 3 is a diagram illustrating a state in which the rain area is applied between the HAPS and the HAPS ground station currently in use, and a feeder link is switched to the other HAPS ground station in the wireless communication system of the related art. The feeder link 111 is switched from the HAPS ground station 103(1) to the HAPS ground station 103(2).

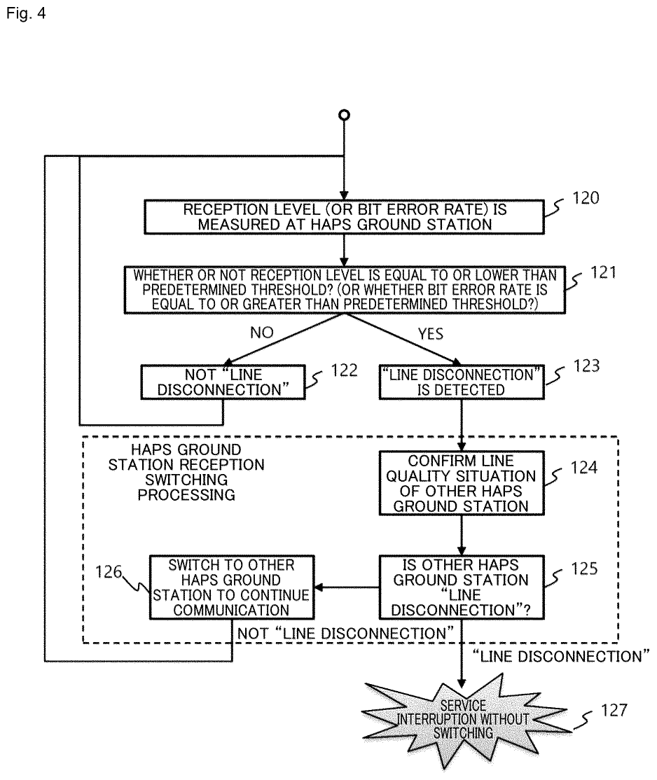

FIG. 4 is a flowchart of processing for switching the feeder link to the other HAPS ground station when the rain area is applied between the HAPS and the HAPS ground station currently in use in the wireless communication system of the related art. First, the HAPS ground station 103(1) currently communicating with the HAPS 101 always measures a reception level or the bit error rate (step 120). Further, the measured reception level or bit error rate is compared with a predetermined threshold (step 121). When the reception level is not lower than the threshold (or when the bit error rate is not higher than the threshold), the HAPS ground station 103(1) determines that there is no “line disconnection” and continues communication (step 122). On the other hand, when the reception level is lower than the threshold (or when the bit error rate exceeds the threshold), the “line disconnection” of the HAPS ground station 103(1) is detected (step 123). Therefore, the HAPS monitoring and control station 106 confirms the line quality situation of the other HAPS ground station 103(2) (step 124). Therefore, a determination is made whether or not the HAPS ground station 103(2) has not been “line disconnection” (step 125). When the HAPS monitoring and control station 106 determines that the line is not disconnected, the HAPS monitoring and control station 106 switches the feeder link from the HAPS ground station 103(1) to the HAPS ground station 103(2) to continue the communication (step 126). When the HAPS ground station 103(2) is also determined to be “line disconnection”, the service is disconnected without performing the switching (step 127).

Thus, in the wireless communication system 100 of the related art, when the rain area 112 is applied between the HAPS 101 and the HAPS ground station 103 currently in use and a line disconnection is detected, the service interruption is avoided by selecting an alternative station from among a plurality of installed HAPS ground stations 103. In this case, processing for detecting the line disconnection on the basis of real-time measurement data and switching the feeder link 111 has been performed.

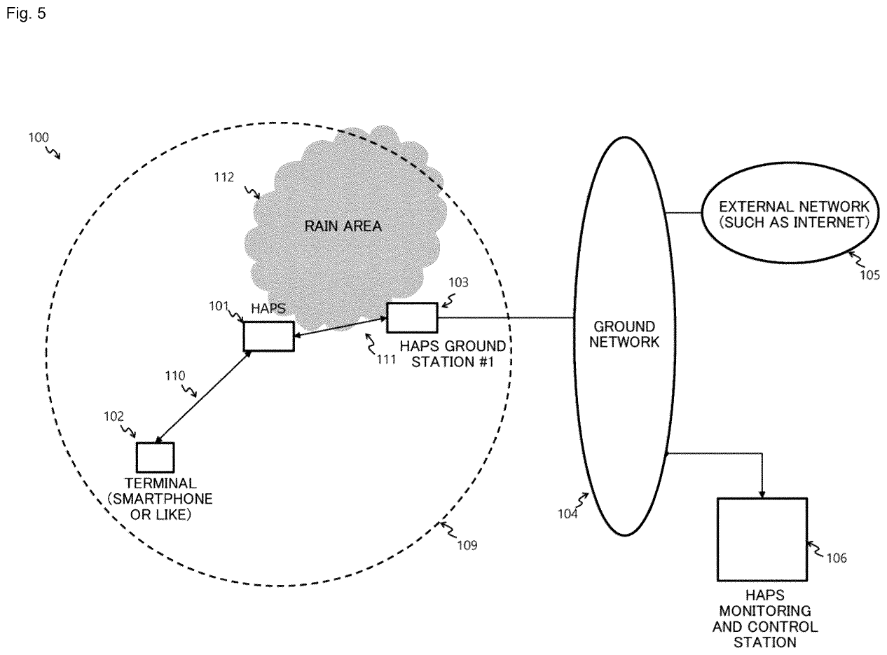

FIG. 5 is a diagram illustrating a state in which the rain area is applied between the HAPS and the HAPS ground station when only one HAPS ground station is present in the wireless communication system of the related art. Thus, the case in which only one HAPS ground station 103 is installed may be realistic.

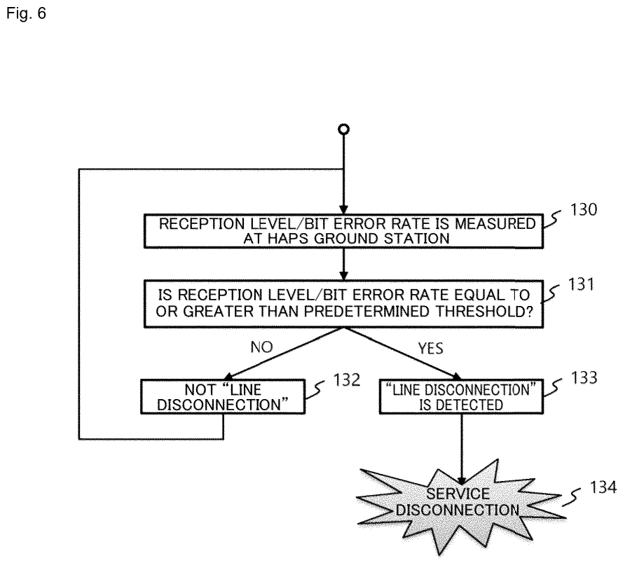

FIG. 6 is a flowchart illustrating a case in which only one HAPS ground station is present in the wireless communication system of the related art. In FIG. 6, steps 130 to 133 are the same as those in FIG. 4. However, since there is only one HAPS ground station 103, when the line disconnection is detected, the service interruption occurs immediately (step 134).

As described above using the comparative example, when only one HAPS ground station 103 is present in the related art, the line quality is likely to deteriorate and the service is likely to be interrupted.

### Embodiment 1

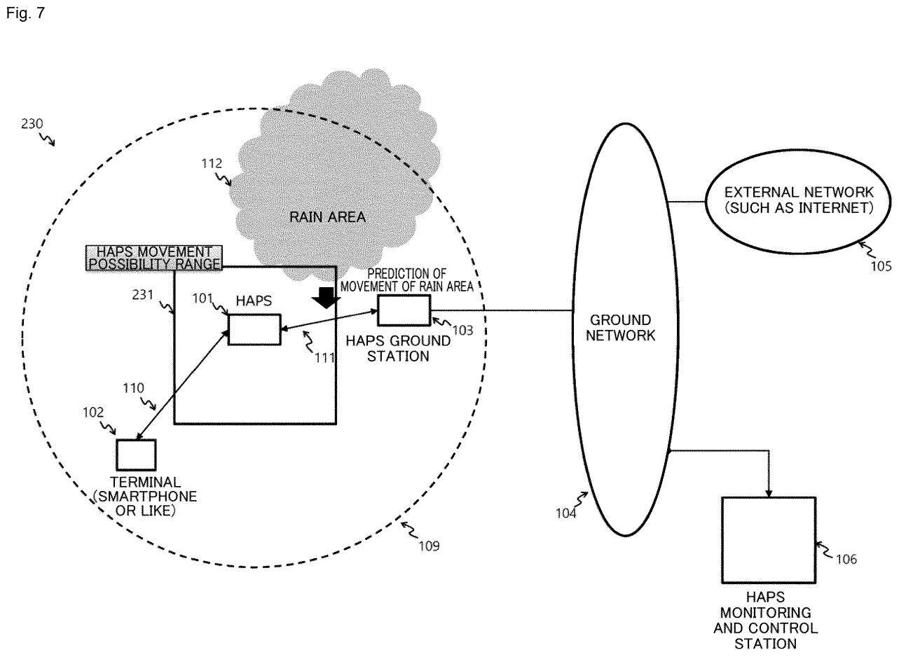

FIG. 7 is a diagram illustrating a state in which the rain area approaches between the HAPS and the HAPS ground station in a wireless communication system according to Embodiment 1 of the present disclosure. The wireless communication system 230 is common to the wireless communication system 100 of the related art, but a movement possibility range 231 is previously determined in the HAPS 101.

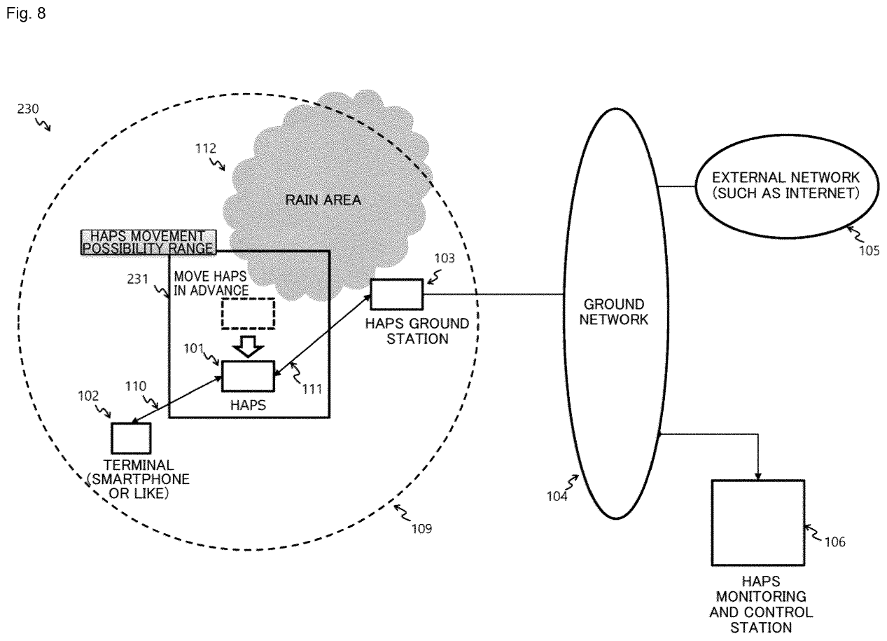

FIG. 8 is a diagram illustrating a state in which the HAPS moves within a movement possibility range before the rain area is applied between the HAPS and the HAPS ground station in the wireless communication system according to Embodiment 1 of the present disclosure. The HAPS 101 is controlled by the HAPS monitoring and control station 106 and moves to a position at which the influence of rainfall is small within a movement possibility range 231.

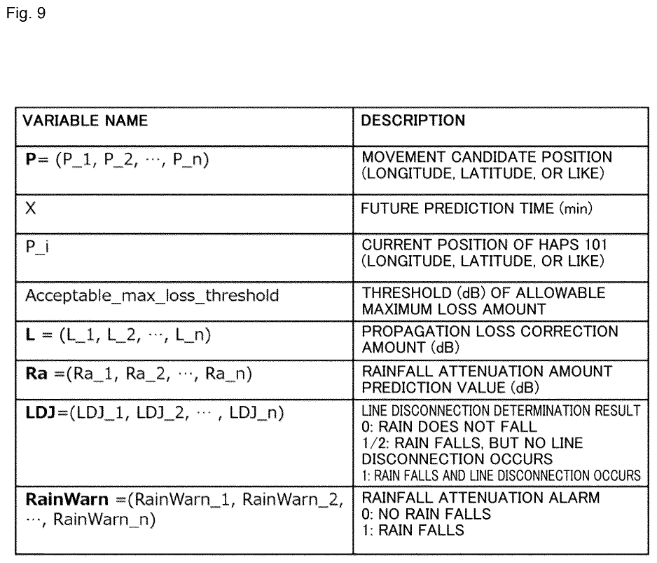

FIG. 9 illustrates a list of parameters used in the position movement processing (step 232) of the HAPS performed by the HAPS monitoring and control station according to Embodiment 1 of the present disclosure.

P=(P_1, P_2, . . . , P_n) is a movement candidate position of the HAPS 101 within the movement possibility range 231. P is a position represented by, for example, longitude, latitude, or the like. X is a future prediction time of the rainfall attenuation amount, and a time unit is, for example, minute. P_i is the current position of the HAPS 101 represented by longitude, latitude, and the like. The Acceptable_max_loss_threshold is a threshold representing the allowable maximum attenuation amount of feeder link communication. L=(L_1, L_2, . . . , L_N) is a propagation loss correction amount with the feeder link distance at the given current position P_i as a reference. Ra=(Ra_1, Ra_2, . . . , Ra_n) is a rainfall attenuation amount prediction value at a movement candidate position P of the HAPS 101. LDJ=(LDJ_1, LDJ_2, . . . , LDJ_n) is a result of the line disconnection determination. RainWarn=(RainWarn_1, RainWarn_2, . . . , RainWarn_n) is a rainfall attenuation alarm.

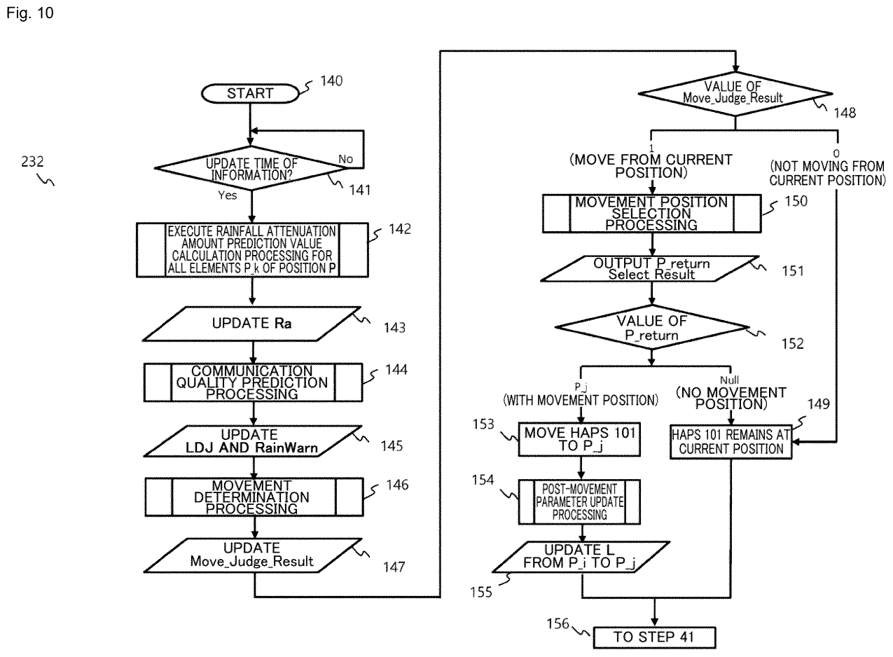

FIG. 10 is a flowchart of the position movement processing (step 232) of the HAPS performed by the HAPS monitoring and control station according to Embodiment 1 of the present disclosure.

First, the HAPS monitoring and control station 106 starts processing (step 140). It is assumed that all the parameters illustrated in FIG. 9 have been calculated at the start point. Further, it is not necessary to move because no rainfall is observed on the feeder link 111 at the current position P_i of the HAPS 101.

Next, the HAPS monitoring and control station 106 determines whether or not it is a time when the weather information is updated (step 141). When it is recognized that it is a time when the weather information is updated, the rainfall attenuation amount prediction value calculation processing is executed for all the elements P_k (k=1, 2, . . . , N) of the movement candidate position P (step 142). Accordingly, the updated rainfall attenuation amount prediction value Ra is obtained (step 143). Further, communication quality prediction processing for predicting the quality of the communication line is executed on the basis of the updated rainfall attenuation amount prediction value Ra (step 144). Accordingly, the updated the line disconnection determination result LDJ and the values of the rainfall attenuation amount alarm RainWarn are obtained (step 145). Further, movement determination processing is executed on the basis of the updated the line disconnection determination result LDJ and the value of the rainfall attenuation amount alarm RainWarn (step 146). As a result, the updated value of the Move_Judge_Result is obtained (step 147). The values of Move_Judge_Result are two values of 0 and 1.

Next, the HAPS monitoring and control station 106 performs processing for determining a value of Move_Judge_Result (step 148). When Move_Judge_Result=0, a determination is made that the HAPS 101 is not moved from the current position P_i, and the HAPS 101 remains at the current position (step 149). On the other hand, when Move_Judge_Result=1, a determination is made that movement is to be performed, and movement position selection processing is executed (step 150). Accordingly, values of P_return and Select_Result are obtained (step 151). A specific position such as P_j or null is returned as a return value to P_return.

Next, the HAPS monitoring and control station 106 performs processing for determining the value of P_return (step 152). When P_return is P_j, this means that the movement position is determined at the position P_j within the movement possibility range 231. Then, the HAPS 101 is moved to the position P_j (step 153). On the other hand, when P_return is null, this means that the movement position has not been found in the entire movement possibility range 231 due to heavy rain. In this case, the HAPS 101 remains at the current position as in the case of Move_Judge_Result=0 (step 149).

When the movement of the HAPS 101 from the position P_i to P_j is completed, the HAPS monitoring and control station 106 performs post-movement parameter update processing (step 154). Accordingly, the current position of the HAPS 101 is updated from P_i to P_j, and the propagation loss correction amount L is also accordingly updated (step 155). Thereafter, the HAPS monitoring and control station 106 waits until the next update time of the weather information (step 156).

As described above, the HAPS monitoring and control station 106 predicts the rainfall attenuation amount of the feeder link 111 on the basis of the weather information. When it is predicted that the communication quality cannot be ensured because of the occurrence of line disconnection due to rainfall attenuation, and a determination is made that movement is necessary, processing for selecting a movement position is further performed. Thus, it is possible to move the HAPS 101 to a position at which the influence of rainfall is small.

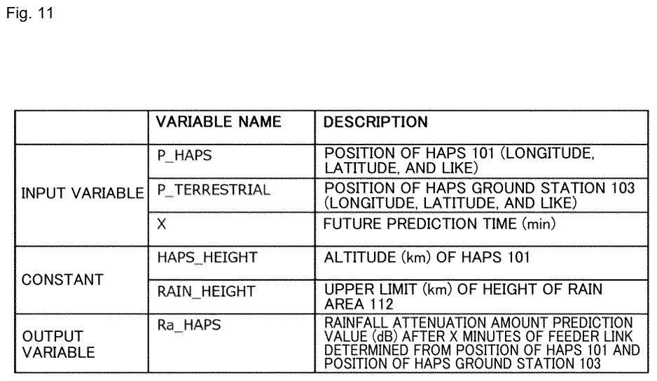

FIG. 11 is a parameter used in the rainfall attenuation amount prediction value calculation processing in step 142. The input variable is a variable necessary for executing the processing. The constant is a constant fixed in advance in the processing. The output variable is a variable obtained as a result of the execution of the processing.

P_HAPS is a position of HAPS 101. P_TERRESTRIAL is the position of the HAPS ground station 103 represented by longitude, latitude, or the like. One feeder link 111 is determined from the P_HAPS and the P_TERRESTRIAL given as input variables. X is the future prediction time of the rainfall attenuation amount.

HAPS_HEIGHT is an altitude of HAPS. In the present embodiment, HAPS_HEIGHT is fixed to 20 km. The RAIN_HEIGHT is an upper limit of the height of the rain area 112. In the present embodiment, RAIN_HEIGHT is fixed to 4 km.

Ra_HAPS is a rainfall attenuation amount prediction value after X minutes of one feeder link 111 determined from P_HAPS and P_TERRESTRIAL.

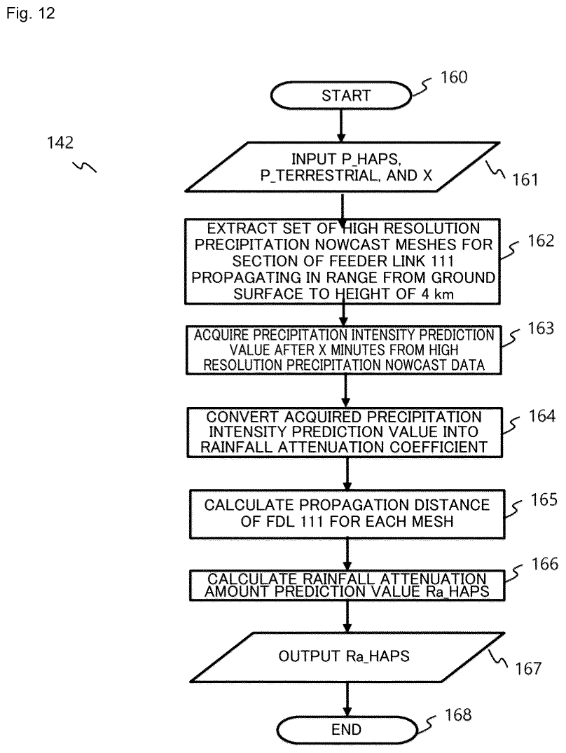

FIG. 12 is a flowchart illustrating details of the rainfall attenuation amount prediction value calculation processing in step 142.

First, the HAPS monitoring and control station 106 starts processing (step 160). Next, the values of P-HAPS, P-TERRESTRIAL, and X are input (step 161). Further, a set of meshes of high resolution precipitation nowcast is extracted for a section propagating in a range from a ground surface to a height of 4 km in the feeder link 111 determined from P_HAPS and P_TERRESTRIAL (step 162). Further, a precipitation intensity prediction value after X minutes is acquired from the high resolution precipitation nowcast data for the set of meshes extracted above (step 163). Further, the acquired precipitation intensity prediction value is converted into a rainfall attenuation coefficient (step 164). Next, a distance at which the feeder link 111 propagates is calculated for each of the meshes extracted in step 162(step 165). Further, a product of the rainfall attenuation coefficient for each mesh and the feeder link distance passing through the mesh is obtained and a sum is calculated to calculate a rainfall attenuation amount prediction value Ra_HAPS (step 166). Then, Ra_HAPS is output (step 167). Finally, the processing ends (step 168).

According to the flow described above, the HAPS monitoring and control station 106 can predict the rainfall attenuation amount for one feeder link 111.

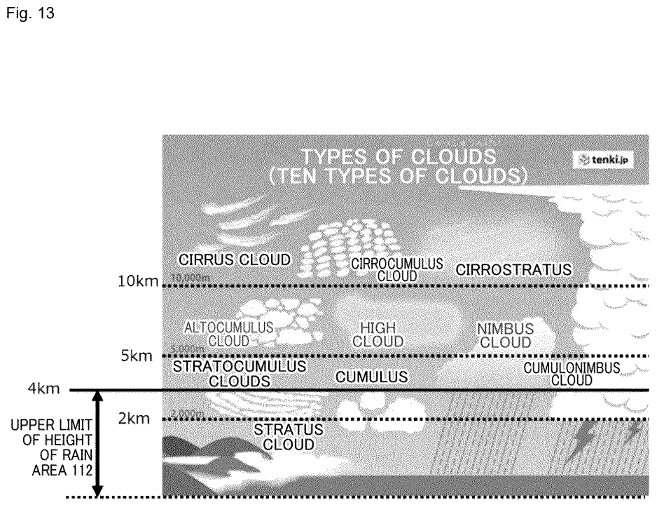

FIG. 13 is a diagram illustrating the type and height of the cloud provided by Non Patent Literature 3. From the figure, the types of rain cloud include a nimbus cloud and a cumulonimbus cloud. A height of the rain area is the highest at the nimbus cloud and is at most 4 km. Therefore, in the present embodiment, the upper limit of the height of the rain area 112 is set to 4 km.

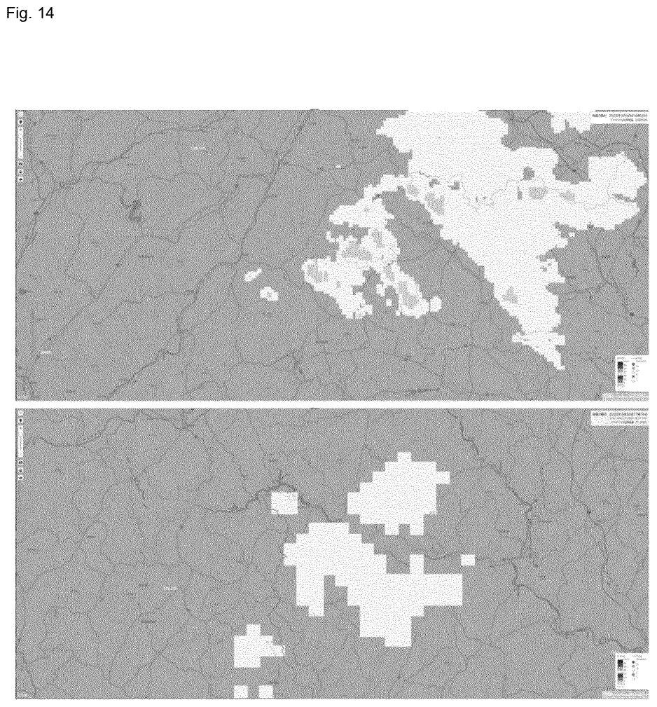

FIG. 14 illustrates an example of precipitation intensity prediction on the basis of high resolution precipitation nowcast data provided from the Meteorological Agency. The precipitation intensity is a rainfall amount per hour when it is assumed that rainfall is continuously and uniformly observed for one hour, and the unit is mm/h. In the high resolution precipitation nowcast data, the whole country of Japan is divided by lattice-shaped meshes, and precipitation intensity prediction value for each mesh is provided at intervals of 5 minutes from a certain time to 60 minutes.

The precipitation intensity prediction value is updated at 5 minutes intervals such as 00 minutes, 05 minutes, 10 minutes, . . . , 55 minutes. Further, the size of the mesh is 250 m square from 5 minutes to 30 minutes after a certain time. On the other hand, the prediction from 35 minutes to 60 minutes after the certain time is 1 km square.

A map in an upper part of FIG. 14 is divided into meshes of 250 m square (hereinafter referred to as 250 m meshes), and the precipitation intensity prediction values up to 5 to 30 minutes are shown. On the other hand, a map in a lower part is divided into meshes of 1 km square (hereinafter referred to as 1 km mesh), and predicted values up to 35 to 60 minutes are shown. Since the maps in the upper and lower parts have the same scale, it is clear that the upper mesh closer to a current time is finer.

From the high resolution precipitation nowcast data, it is possible to acquire a rainfall intensity prediction value at 5 minutes intervals from 5 minutes to 30 minutes after time t=T for each of 250 m meshes m_1, . . . , m_i. Similarly, for each of the 1 km meshes M_1, . . . , M_i, a rainfall intensity prediction value can be acquired from 35 minutes to 60 minutes after time t=T. Also, it is possible to acquire the information of the current time t=T. In the present embodiment, the rainfall attenuation amount prediction value is calculated by acquiring these pieces of information.

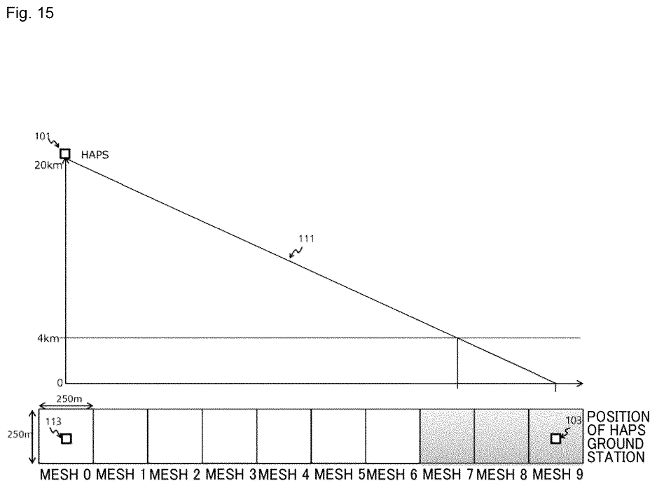

FIG. 15 is a diagram illustrating an extraction principle of a set of high resolution precipitation nowcast meshes in step 162.

In the example illustrated in FIG. 15, the altitude of the HAPS 101 is 20 km as a prerequisite according to the description of Non Patent Literature 2. In addition, regarding e positional relationship between the HAPS 101 and the HAPS ground station 103, it is assumed that the HAPS ground station 103 is present in a direction of the true east of the HAPS. Further, a distance between a point 113 at which the position of the HAPS is projected on the ground surface and the HAPS ground station 103 is 2250 m, that is, 10 250 meshes. It is also assumed that both the HAPS 101 and the HAPS ground station 103 are located at a center of 250 m mesh. Further, an upper limit of the altitude of the rain area 112 is set to 4 km as compared with Non Patent Literature 3. Further, a frequency band of the feeder link 111 is set to a 38 GHz band as compared with Non Patent Literature 2.

The feeder link 111 is represented by a straight line connecting the HAPS 101 and the HAPS ground station 103. The total number of 250 m meshes to which a straight line connecting the HAPS 101 and the HAPS ground station 103 is applied is 10 (mesh 0 to mesh 9). However, when the upper limit of the altitude of the rain area 112 is taken into consideration, the radio wave is not attenuated because rain does not fall in a section exceeding the altitude 4 km. Therefore, the meshes 0 to 6 are independent of the prediction of the rain area, and the meshes related to the prediction are only three meshes 7 to 9.

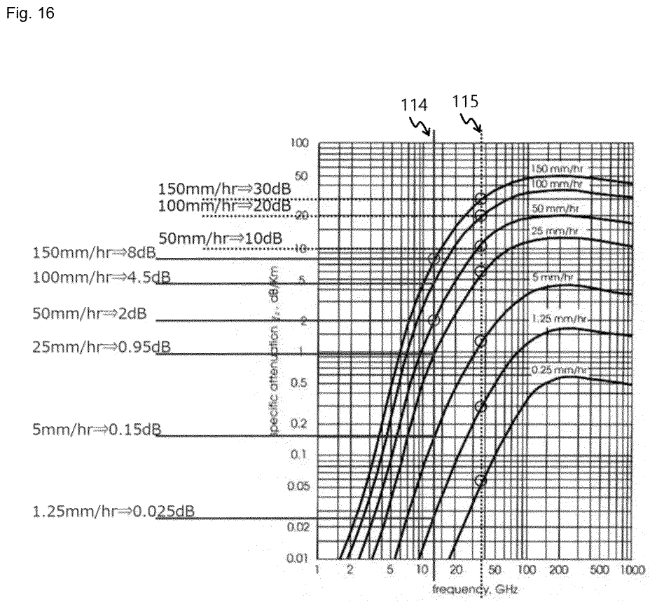

FIG. 16 is a diagram illustrating details of a method of converting the precipitation intensity prediction value into of rainfall attenuation coefficient in step 164. In Non Patent Literature 5, frequency characteristics of the rainfall attenuation coefficient are shown for each precipitation intensity. However, the rainfall attenuation coefficient is an attenuation amount of a radio wave due to rainfall, and is expressed per 1 km propagation distance. A unit of rainfall attenuation coefficient is dB/km. For example, a solid line 114 indicates the result of reading the value of the rainfall attenuation coefficient for each precipitation intensity (mm/h) for the radio wave of 12.5 GHz. Similarly, a dotted line 115 indicates the result of reading the value of rainfall attenuation coefficient for the radio wave of 38 GHz.

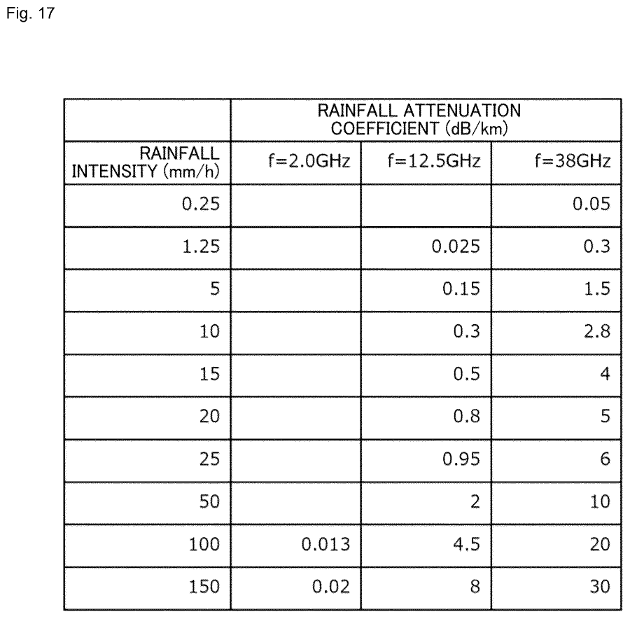

FIG. 17 illustrates a result of conversion of the precipitation intensity prediction value into a rainfall attenuation coefficient prediction value. The results of reading FIG. 16 for f=2 GHz, 12.5 GHz, and 38 GHz are summarized.

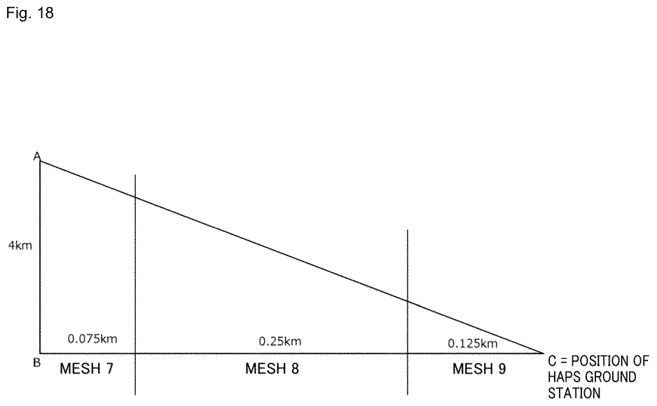

FIG. 18 is a diagram illustrating details of a method of calculating a propagation distance of the feeder link 111 for each mesh in step 165. A right-angled triangle ABC is a right-angled triangle whose oblique side is a section in which a range from the ground surface to a height of 4 km in a straight line indicating the feeder link 111 illustrated in FIG. 15 propagates.

In the following description, the propagation distance of the feeder link 111 is simply referred to as the feeder link distance.

The right-angled triangle ABC is similar to the right-angled triangle having a straight line connecting the HAPS 101 and the HAPS ground station 103 illustrated in FIG. 15 as an oblique side. Therefore, the BC distance is determined by the following equation.

$$20 km : 2.25 km = 4 km : BC \qquad ( Equation 1 )$$

$$BC = 0.45 km \qquad ( Equation 2 )$$

Further, the distance of AC is obtained from theorem of three squares by the following equation.

$$A C = sqrt ( AB \hat{} 2 + BC \hat{} 2 ) = sqrt ( 4 \hat{} 2 + 0.45 \hat{} 2 ) = 4.02523 km \qquad ( Equation 3 )$$

Further, as described in FIG. 15, 250 m meshes on which a straight line AC is applied are meshes 7 to 9. The feeder link distance in each mesh is given by the following equation.

$$The feeder link distance of the portion of \\ the mesh 7 is 4.02523 \times 75 / 450 = 0.670872 km \qquad ( Equation 4 )$$

$$The feeder link distance of the portion of \\ the mesh 8 is 4.02523 \times 250 / 450 = 2.23624 km \qquad ( Equation 5 )$$

$$The feeder link distance of portion of \\ the mesh 9 is 4.02523 \times 125 / 450 = 1.11812 km \qquad ( Equation 6 )$$

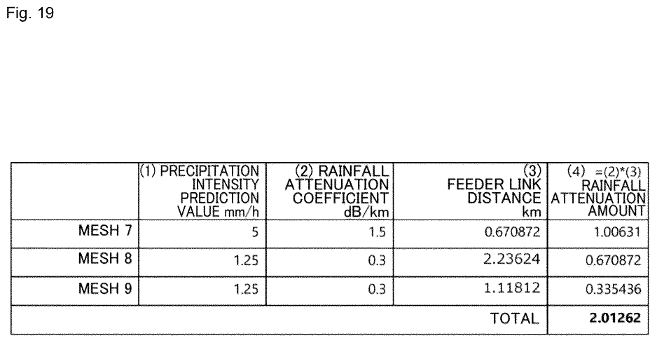

FIG. 19 is a diagram illustrating details of the method of calculating the rainfall attenuation amount prediction value Ra_HAPS in step 166. In the example illustrated in FIG. 19, the precipitation intensity prediction values of the meshes 7 to 9 are 5 mm/H, 1.25 mm/h, and 1.25 mm/H. A rainfall attenuation amount in each mesh is obtained as a product of a rainfall attenuation coefficient in each mesh and a feeder link distance in each mesh. Further, a rainfall attenuation amount prediction value of the feeder link 111 is obtained by taking a sum of the rainfall attenuation amounts from the mesh 7 to the mesh 9.

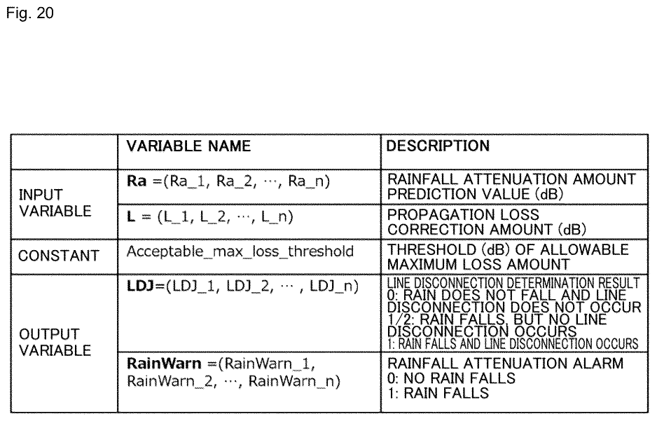

FIG. 20 illustrates parameters used in the communication quality prediction processing in step 144.

Ra is the rainfall attenuation amount prediction value. L represents the propagation loss correction amount. These two are input variables. Acceptable_max_loss_threshold is a threshold of the allowable maximum loss amount, and is defined as a constant in this case.

LDJ=(LDJ_1, LDJ_2, . . . , LDJ_n) is the result of the line disconnection determination. The values taken by the LDJ are three values of 0, ½, and 1. RainWarn=(RainWarn_1, RainWarn_2, . . . , RainWarn_n) is a rainfall attenuation alarm. The values taken by the RainWarn are two values of 0 and 1. These two parameters are output variables.

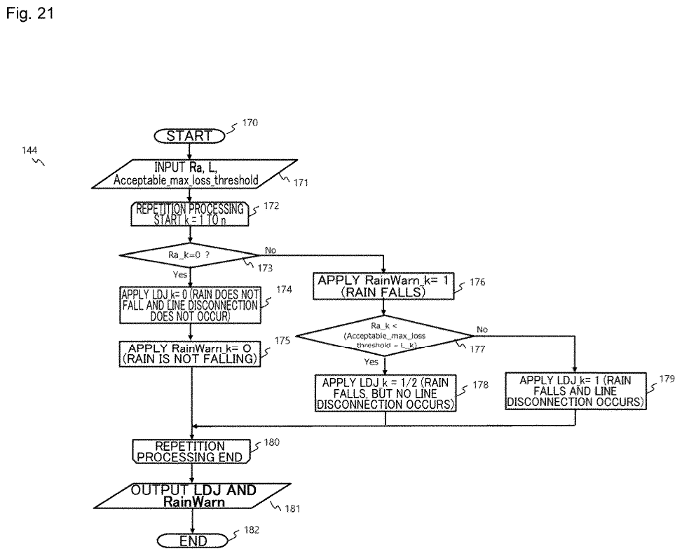

FIG. 21 is a flowchart illustrating details of the communication quality prediction processing in step 144.

First, the HAPS monitoring and control station 106 starts processing (step 170). Next, values of Ra, L, Acceptable_max_loss_threshold are input (step 171). Next, repetition processing from k=1 to n starts (step 172). In the repetition processing, it is first determined whether Ra_k=0 (step 173). When it is recognized that Ra_k=0, LDJ_k=0 is applied (step 174). LDJ_k=0 means that no rain falls at the position P_k and no line disconnection occurs. Further, RainWarn_k=0 is applied (step 175). RainWarn_k=0 means that no rain falls at the position P_k.

On the other hand, when it is not recognized in step 173 that Ra_k=0, the HAPS monitoring and control station 106 applies RainWarn_k=1(step 176). RainWarn_k=1 means that rain falls at the position P_k. Further, a magnitude relationship between Ra_k and a threshold (Acceptable_max_loss_threshold-L_k) of the allowable maximum loss amount corrected by the propagation loss correction amount is determined (step 177). When Ra_k<(Acceptable_max_loss_threshold-L_k) is recognized, LDJ_k=½ is applied (step 178). LDJ_k=½ means that, although rain falls at the position P_k, the rainfall attenuation amount is smaller than the threshold, an thus, the line is not disconnected. On the other hand, when Ra_k<(Acceptable_max_loss_threshold-L_k) is not recognized, LDJ_k=1 is applied (step 179). LDJ_k=1 means that rain falls at the position P_k and the rainfall attenuation amount become equal to or greater than the threshold, and thus, line disconnection occurs. This is content of the repetition processing.

When the repetition processing is completed from k=1 to n, the repetition processing ends (step 180). Next, LDJ and RainWarn are output (step 181). Finally, the processing ends (step 182).

As described above, the HAPS monitoring and control station 106 can predict whether or not the line disconnection of the feeder link 111 occurs due to rainfall at the movement candidate position of the HAPS 101.

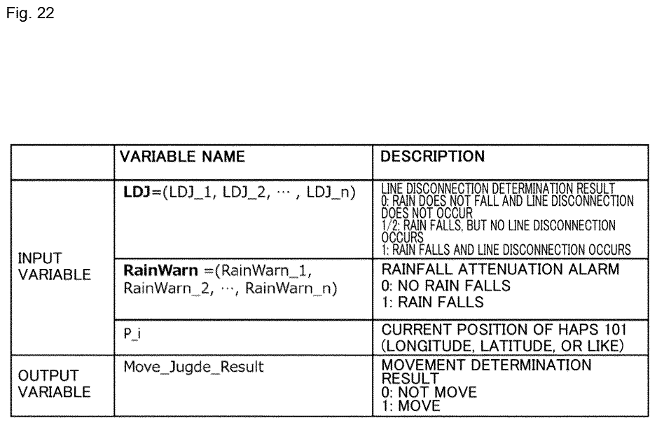

FIG. 22 illustrates parameters used in the movement determination processing in step 146.

LDJ is the result of the line disconnection determination. RainWarn is a rainfall attenuation alarm. P_i is the current position of the HAPS 101. These variables are input variables.

Move_Judge_Result of the output variable is the result of movement determination. The values taken by the Move_Judge_Result are two values of 0 and 1.0 indicates that the HAPS 101 does not move, and 1 indicates that the HAPS 101 moves.

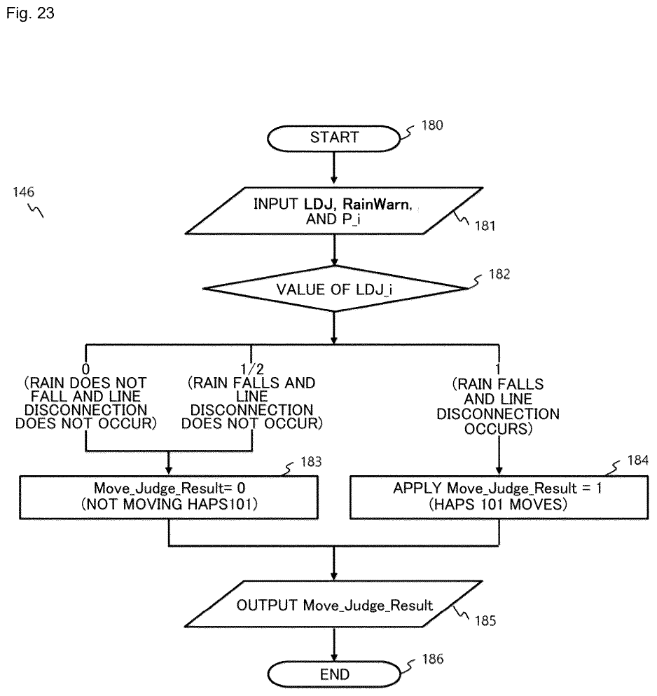

FIG. 23 is a flowchart illustrating details of the movement determination processing in step 146.

First, the HAPS monitoring and control station 106 starts processing (step 180). Next, LDJ, RainWarn, and P_i are input (step 181). Next, processing for determining the value of LDJ_i corresponding to the current position P_i of the HAPS 101 is performed (step 182). When LDJ_i=0, a determination is made that the HAPS 101 does not move because rain does not fall at the current position, and Move_Judge_Result=0 is applied (step 183). Further, when LDJ_i=½, a determination is made that the HAPS 101 does not move because it is predicted that rain falls at the current position, but no line disconnection occurs, and Move_Judge_Result=1 is applied (step 183). On the other hand, when LDJ_i=1, a determination is made that the HAPS 101 moves because it is predicted that rain falls at the current position and the line disconnection occurs, and Move_Judge_Result=1 is applied (step 184). Next, Move_Judge_Result is output (step 185). Finally, the processing ends (step 186).

As described above, the HAPS monitoring and control station 106 can determine whether or not the HAPS 101 is moved from the current position. In the example illustrated in FIG. 23, Move_Judge_Result=0 is applied when LDJ_i=½. That is, a determination is made that the HAPS 101 does not move in a case in which the line disconnection does not occur even though the rain falls. However, Move_Judge_Result=1 may be applied when LDJ_i=½. That is, a determination may be made that the HAPS 101 moves to search for a place in which rain is not falling, in a case in which the line disconnection does not occur even though the rain falls.

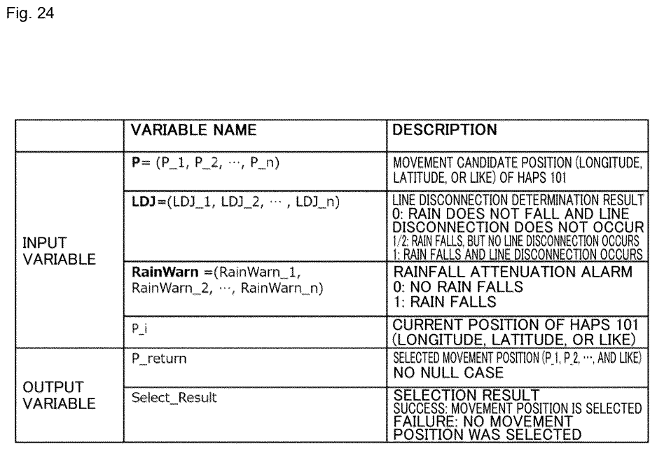

FIG. 24 illustrates parameters used in the movement position selection processing in step 150.

P is a movement candidate position of the HAPS 101. LDJ is the result of the line disconnection determination. RainWarn is a rainfall attenuation alarm. P_i is the current position of the HAPS 101. These variables are input variables.

P_return is the selected movement position. The value taken by P_return is any position selected from among the movement candidate positions. However, when the values of P_1, P_2, . . . , P_n to be taken by P_return are not found, null is output. Select_Result is a selection result. The values taken by Select_Result are two values of success and failure, and indicates that the movement position has been selected or the movement position has not been selected.

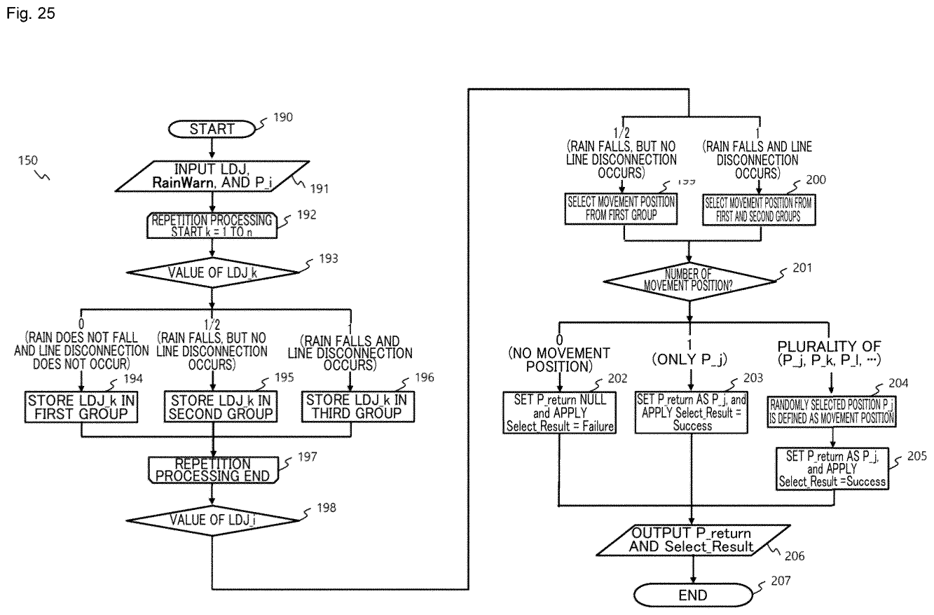

FIG. 25 is a flowchart illustrating details of the movement position selection processing in step 150.

First, the HAPS monitoring and control station 106 starts processing (step 190). Next, P, LDJ, RainWarn, and P_i are input (step 191), and then the repetition processing from k=1 to n starts (step 192). In the repetition processing, first, processing for determining the value of LDJ_k at the position P_k is performed (step 193). When LDJ_k=0, LDJ_k is stored in a first group (step 194). When LDJ_k=½, LDJ_k is stored in a second group (step 195). When LDJ_k=1, LDJ_k is stored in a third group (step 196). This is content of the repetition processing.

The first group is a group in which it is predicted that rain does not fall and line disconnection does not occur. Further, the second group is a group in which it is predicted that rain falls, but no line disconnection occurs. Further, the third group is a group in which it is predicted that rain falls and line disconnection occurs.

After the repetition processing from k=1 to n is completed, the repetition processing ends (step 197). Next, processing for determining the value of LDJ_i corresponding to the current position P_i of the HAPS 101 is performed (step 198). When LDJ_i=½, the movement position is selected from the first group (step 199). When LDJ_k=1, the movement position is selected from the first group and the second group (step 200). However, in step 200, it is assumed that the priority of the first group is higher as the movement position than that of the second group.

Next, the number of the selected movement positions is determined (step 201). When the number of movement positions is 0, this means that the movement positions have not found because rain falls over the entire area of the movement candidate positions P. Therefore, P_return is set to null (no), and select_Result=failure is applied (step 202). On the other hand, when the movement position is only one of P_j, P_return is set to P_j, and Select_Result=Success (step 203). Further, when there are a plurality of movement candidates P_j, P_k, P_l, . . . , the randomly selected position P_j is set as a movement position (step 204). Further, P_return is set to P_j, and Select_Result=Success (step 205).

Next, P_return and Select_Result are output (step 206). Finally, the processing ends (step 207).

As described above, the HAPS monitoring and control station 106 can search for a position predicted to have less influence of rainfall than that staying at the current position from among the movement candidate positions of the HAPS 101, and can select one of the movement candidate positions.

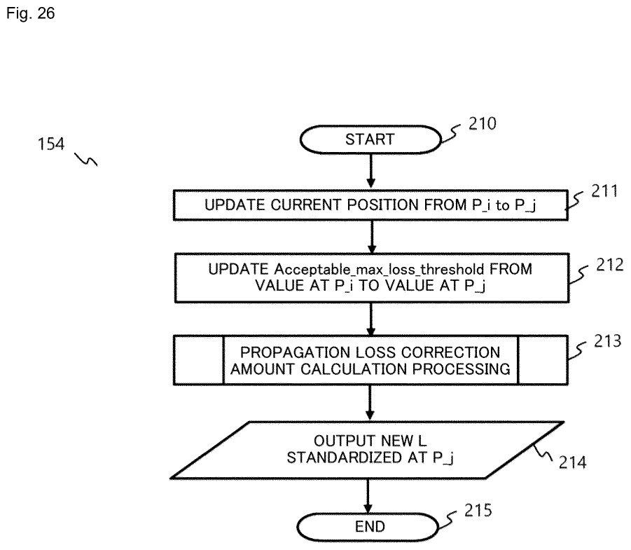

FIG. 26 is a flowchart illustrating details of the post-movement parameter update processing in step 154.

First, the HAPS monitoring and control station 106 starts processing (step 210). It is assumed that the movement of the HAPS 101 from the position P_i to the position P_j is completed at the start point of time. Next, the current position of the HAPS 101 is updated from P_i to P_j (step 211). Further, the value of the threshold

Acceptable_max_loss_threshold of the allowable maximum attenuation amount is updated from a value at the position P_i to a value at the position P_j (step 212). In this case, a threshold Acceptable_max_loss_threshold of the allowable maximum attenuation amount at the position P_j is obtained by the following equation. Here, L_j represents the propagation loss correction amount (dB) at the position P_j.

$$Acceptable\_max \_loss \_threshold at P\_j = Acceptable\_max \_loss \_threshold - L\_j at P\_i \qquad ( Equation 7 )$$

Next, a propagation loss correction amount calculation processing is executed (step 213). This makes it possible to calculate new propagation loss correction amounts L=(L_1, L_2, . . . , L_n) standardized at the current position P_j of the updated HAPS 101. Further, the new L standardized at the current position P_j is output (step 214). Finally, the processing ends (step 215).

As described above, the HAPS monitoring and control station 106 can update the parameters with the completion of movement of the HAPS 101.

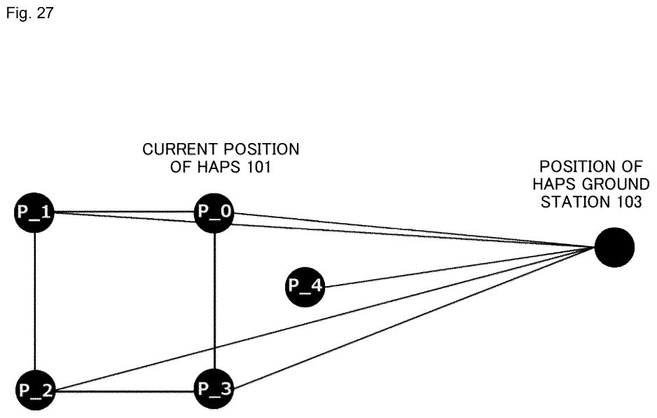

FIG. 27 is a diagram illustrating a calculation principle for a propagation loss correction amount calculated in the propagation loss correction amount calculation processing in step 213.

It is assumed that the current position of the HAPS 101 is P_HAPS=P_0, and the movement candidate position of the HAPS 101 is P_k (k=1 to 4).

For example, a case in which the current position P_0 is moved to any of positions P_1, P_2 and P_3 is considered. In this case, a distance to arrival at the HAPS ground station 103 becomes longer than the current position P_0. Therefore, the propagation loss increases as compared to that at the current position P_0. The increment of the loss involved in the movement of the HAPS 101 is the propagation loss correction amount.

It is well known that an amount of propagation loss is inversely proportional to a square of the distance. This is caused by the fact that the radio wave transmitted from one point in a space spreads in a spherical shape. When the propagation distance becomes double, a surface area of the sphere becomes four times, and power per unit area, that is, the power density becomes ¼. When a size of the antenna for receiving the radio wave is constant, the reception power becomes ¼.

Although the example of FIG. 27 has been described with reference to a plane figure for the sake of simplicity, the same applies to a spatial figure.

As described above, an amount of loss of the feeder link 111 caused by the movement can be taken into consideration by obtaining an amount of propagation loss correction for the movement candidate position of the HAPS 101.

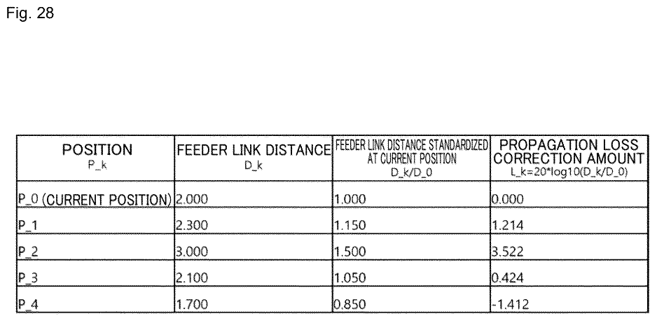

FIG. 28 illustrates an example of the result of calculation of the propagation loss correction amount.

A feeder link distance D_k between the HAPS 101 and the HAPS ground station 103 is a distance of a straight line connecting the position P_k and the position of the HAPS ground station 103. The example in FIG. 28 shows a case in which the feeder link distances from positions P_0 to P_4 are 2.000, 2.3000, 3.000, 2.100, and 1.700, respectively. However, it is assumed that the unit of the feeder link distance is arbitrary.

The feeder link distance D_k/D_0 standardized at the current position is the feeder link distance at the position P_k standardized at the feeder link distance D_0 at the current position P_0 of the HAPS 101.

The propagation loss correction amount L_k at the position P_k is a propagation loss at the position P_k with the propagation loss at the current position of the HAPS 101 as a reference, and is obtained by the following equation.

$$L\_k = 20 \times log 10 ( D\_k / D\_ 0 ) \qquad ( Equation 8 )$$

For example, when movement from positions P_0 to P_1 is performed, the attenuation amount of the feeder link 111 increases by a propagation loss correction amount of 1.214 dB. Therefore, even when a maximum of 8 dB of rainfall attenuation is allowed at the current position P_0, the rain attenuation is only allowed up to (8−1.214)=6.786 dB at the position P_1, and the maximum allowable loss amount is reduced.

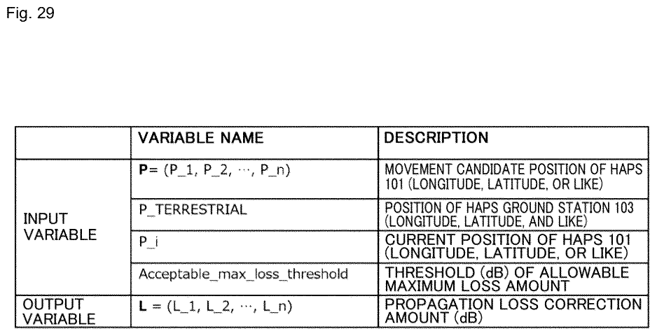

FIG. 29 illustrates parameters used in the propagation loss correction amount calculation processing in step 213.

P is a movement candidate position of the HAPS 101. P_TERRESTRIAL is a position of the HAPS ground station 103. P_i is the current position of the HAPS 101. Acceptable_max_loss_threshold is a threshold of the allowable maximum loss amount. These variables are input variables.

The output variables L=(L_1, L_2, . . . , L_N) are propagation loss correction amounts (dB).

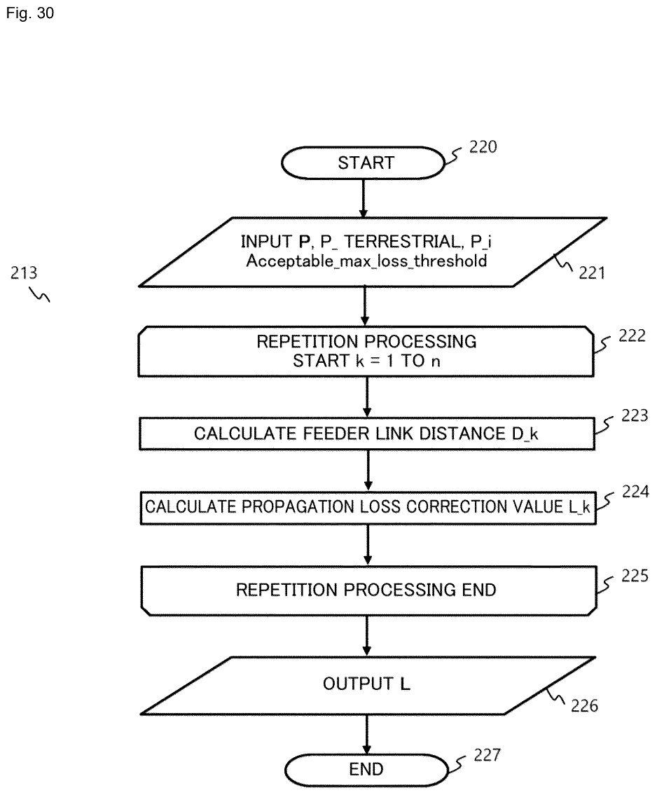

FIG. 30 is a flowchart illustrating details of the propagation loss correction amount calculation processing in step 213.

First, the HAPS monitoring and control station 106 starts processing (step 220). Next, P, P_TERRESTRIAL, P_i, and Acceptable_max_loss_threshold are input (step 221), and then the repetition processing from k=1 to n starts (step 222). In the repetition processing, first, the feeder link distance D_k between the HAPS 101 and the HAPS ground station 103 is calculated for the position P_k (step 223). Next, the propagation loss correction amount L_k expressed by the following equation is calculated (step 224). However, D_k/D_i is the feeder link distance standardized by the feeder link distance D_i at the current position P_i. Here, content of the repetition processing are described.

$$L\_k = 20 \times log 10 ( D\_k / D\_i ) \qquad ( Equation 9 )$$

After the repetition processing of k=1 to n is completed, the repetition processing ends (step 225). Further, L is output (step 226). Finally, the processing ends (step 227).

As described above, the HAPS monitoring and control station 106 calculates the propagation loss correction amount L=(L_1, L_2, L_n) standardized at the current position P_i for each of the movement candidate positions P=(P_1, P_2, P_n) of the HAPS 101.

As described above with reference to FIGS. 7 to 30, in the wireless communication system 230 according to Embodiment 1 of the present disclosure, it is possible to predict an influence of rainfall attenuation on the communication quality on a propagation path of the feeder link 111 in advance. When it is predicted that the communication quality cannot be ensured at the current position due to rainfall, a position predicted to have less influence of rainfall than the current position is selected from among candidate positions within the movement possibility range 231 of the HAPS 101 that has been set in advance. Moving the HAPS 101 to the selected position makes it possible to ensure communication quality and realize improvement of the line operation rate.

The wireless communication system 230 of the present embodiment can be applied to all frequencies, but is particularly effective for a high frequency band in which an influence on communication quality due to rainfall cannot be ignored. This also applies to the following embodiments.

Further, in the present embodiment, a case in which the wireless relay station in the NTN is the HAPS 101 has been described, but the wireless relay station may be a drone or the like. The same applies to all of the following Embodiments.

Further, although the configuration in which only one HAPS ground station 103 is provided has been described in the present embodiment, a plurality of HAPS ground stations 103 may be present. The same applies to all of the following Embodiments.

Here, the processing performed by the HAPS monitoring and control station 106 in the present disclosure may be executed by executing a program with a computer including a CPU and a memory and having a program stored in the memory. Alternatively, the program may be executed using an integrated circuit such as a Field Programmable Gate Array (FPGA). Also, the program may be provided by being recorded on a storage medium, or may be provided through a network.

In the present embodiment, a case in which the processing for acquiring weather information of the high resolution precipitation nowcast data is performed by the HAPS monitoring and control station 106 has been described. However, the processing may be performed by HAPS 101. Further, the same applies to the rainfall attenuation amount prediction value calculation processing (step 142), the communication quality prediction processing (step 144), the movement determination processing (step 146), and the movement position selection processing (step 150). The same applies to all of the following Embodiments.

For a control method for moving the HAPS 101, for example, the HAPS 101 may be controlled by using a part of the data of the feeder link 111 from the HAPS monitoring and control station 106. Alternatively, the HAPS 101 may be controlled from the HAPS monitoring and control station 106 by inter-HAPS communication. However, the inter-HAPS communication means communication between the HAPS 101 and another adjacent HAPS. Further, the HAPS 101 may be controlled from the HAPS monitoring and control station 106 via a GEO (geostationary satellite). The same applies to all of the following Embodiments.

Further, in the communication quality prediction processing executed in step 144 of the present embodiment, it is predicted whether or not the line disconnection of the feeder link 111 occurs, but a criterion for determining the communication quality is not limited to the line disconnection. The same applies to all of the following Embodiments.

[Description of Correspondence Relationship with Terms Used in Claims]

The HAPS monitoring and control station 106 described in the present embodiment is named as a wireless relay station monitoring control device. Similarly, the HAPS ground station 103 is named as a ground station.

### Embodiment 2

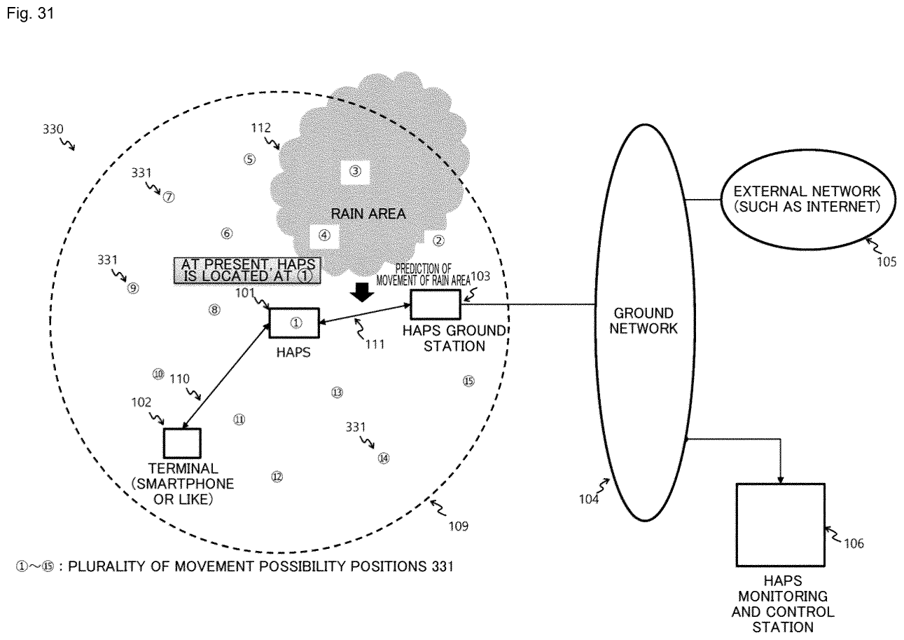

FIG. 31 is a diagram illustrating a state in which the rain area approaches between the HAPS and the HAPS ground station in a wireless communication system according to Embodiment 2 of the present disclosure. Although the wireless communication system 330 is common to the wireless communication system 230 of Embodiment 1, the plurality of movement possibility positions 331 scattered in the HAPS area 109 are predetermined in the HAPS 101.

In the example of FIG. 31, it is assumed that the HAPS 101 has 15 movement possibility positions 331 from first to the fifteenth positions, and the current position is at the first movement possibility position.

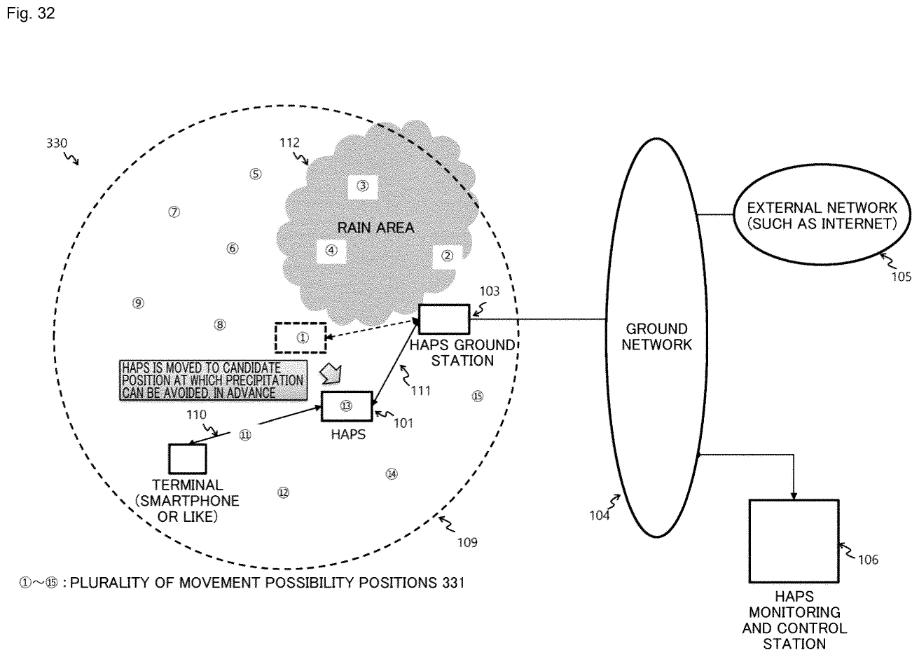

FIG. 32 is a diagram illustrating a state in which the HAPS 101 moves to another movement possibility position before the rain area is applied between the HAPS and the HAPS ground station in the wireless communication system according to Embodiment 2 of the present disclosure. The HAPS 101 moves to a position at which the influence of rainfall is small among the plurality of movement possibility positions 331.

In the present embodiment, the position movement processing (step 232) of the HAPS 101 performed by the HAPS monitoring and control station 106 is common to that of Embodiment 1. However, the plurality of movement possibility positions 331 scattered in the HAPS area 109 are set to the movement candidate positions P=(P_1, P_2, . . . , P_n)

Further, a series of processing included in the position movement processing (step 232) of the HAPS 101 are also common. That is, these are the rainfall attenuation amount prediction value calculation processing (step 142), the communication quality prediction processing (step 144), the movement determination processing (step 146), the movement position selection processing (step 150), and the post-movement parameter update processing (step 154). Further, the propagation loss correction amount calculation processing (step 213) is also common.

Further, in the present embodiment, the movement candidate positions P are scattered, and calculation such as the position movement processing (step 232) of the HAPS 101 may be performed for each position. In this case, it is not necessary to calculate the movement possibility range 231 comprehensively as in Embodiment 1, and it can be said that the calculation load is small. Since the calculation load is small, a range in which the movement possibility positions 331 are distributed can be widened in Embodiment 2.

As described above, in the wireless communication system 330 according to Embodiment 2 of the present disclosure, the plurality of movement possibility positions 331 are predetermined with respect to the HAPS 101. When it is predicted that communication quality using the feeder link 111 cannot be ensured due to rainfall, the HAPS 101 is moved from the current position to another movement possibility position 331. This makes it possible to ensure communication quality and realize improvement of the line operation rate.

### Embodiment 3

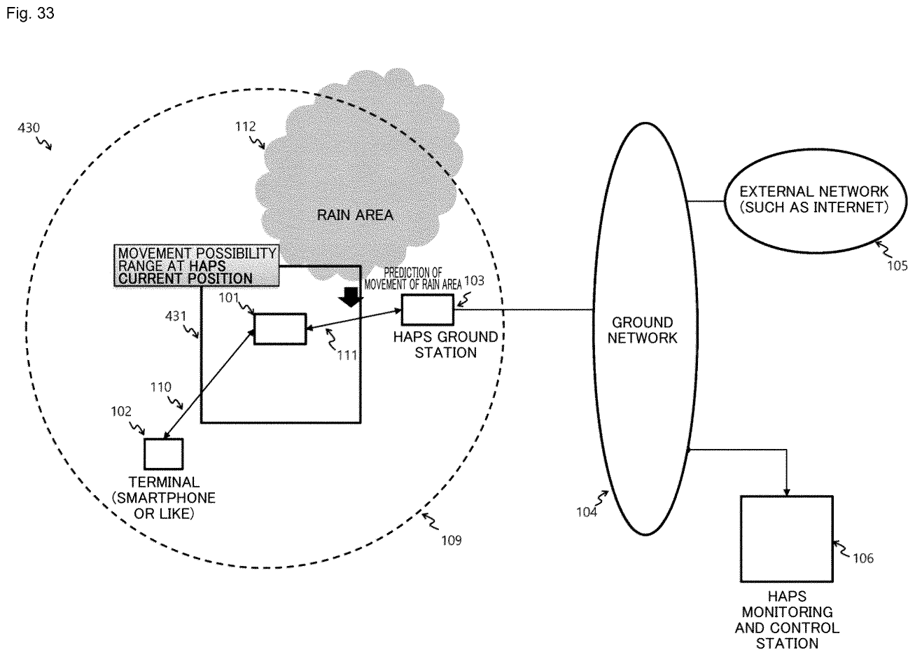

FIG. 33 is a diagram illustrating a state in which the rain area approaches between the HAPS and the HAPS ground station in a wireless communication system according to Embodiment 3 of the present disclosure. The wireless communication system 430 is common to the wireless communication system 230 of Embodiment 1, but the movement possibility range 431 corresponding to the current position is predetermined in the HAPS 101.

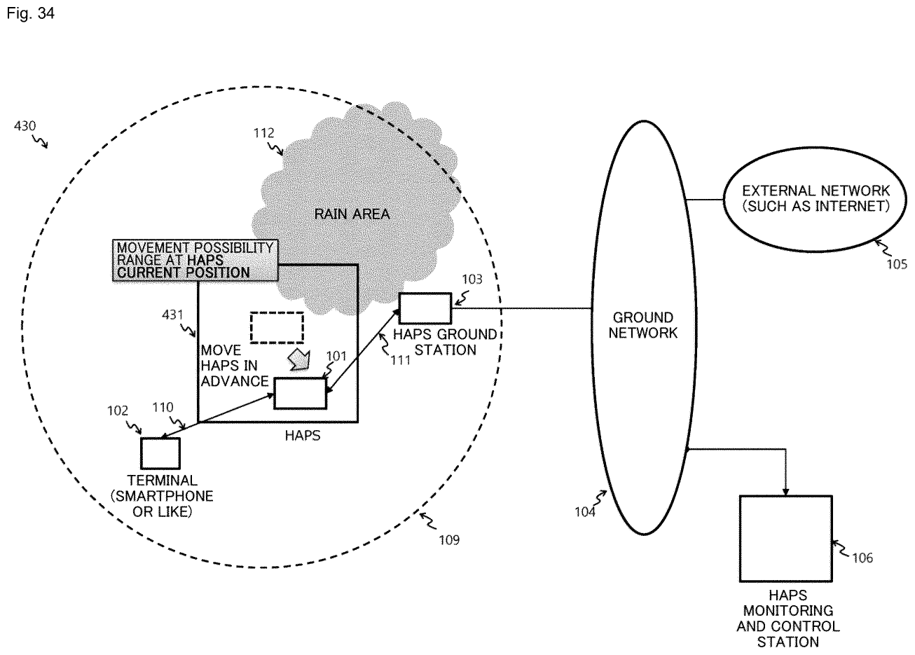

FIG. 34 is a diagram illustrating a state in which the HAPS moves within a movement possibility range corresponding to the current position before the rain area is applied between the HAPS and the HAPS ground station in the wireless communication system according to Embodiment 3 of the present disclosure. The HAPS 101 moves to a position at which the influence of rainfall is less within the movement possibility range 431 corresponding to the current position.

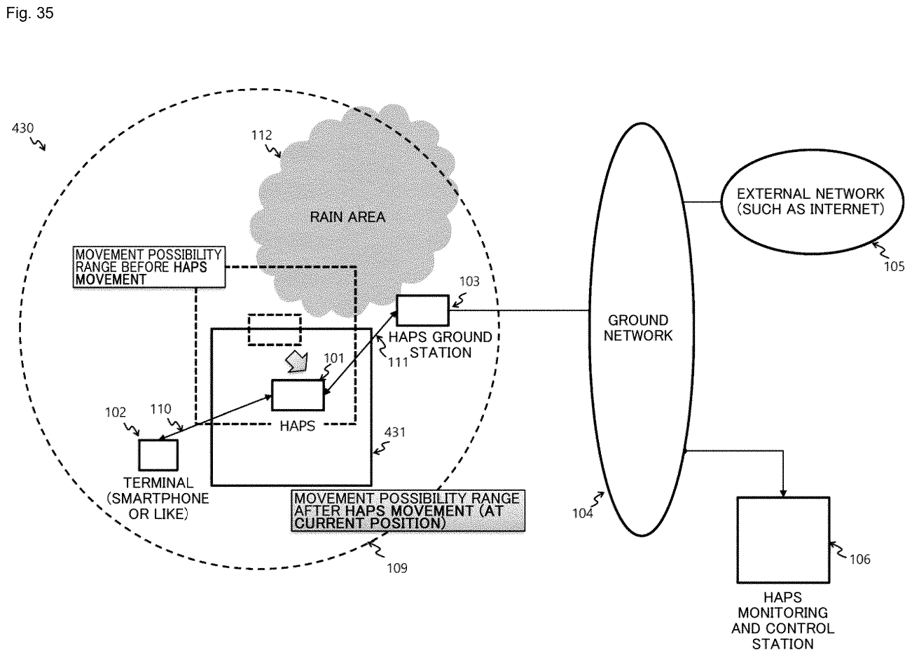

FIG. 35 is a diagram illustrating a newly determined movement possibility range according to the position after the HAPS moves in the wireless communication system according to Embodiment 3 of the present disclosure. A movement possibility range 431 corresponding to the current position is newly determined by the movement of the HAPS 101.

In the present embodiment, the position movement processing (step 232) of the HAPS 101 performed by the HAPS monitoring and control station 106 is common to that of Embodiment 1. However, P=(P_1, P_2, . . . , P_n) is a movement candidate position within the movement possibility range 431 corresponding to the current position of the HAPS 101.

Further, the rainfall attenuation amount prediction value calculation processing (step 142), the communication quality prediction processing (step 144), the movement determination processing (step 146), and the movement position selection processing (step 150) are common. However, in the present embodiment, since the HAPS 101 has the movement possibility range 431 corresponding to the current position, the post-movement parameter update processing (step 154) is different from Embodiment 1.

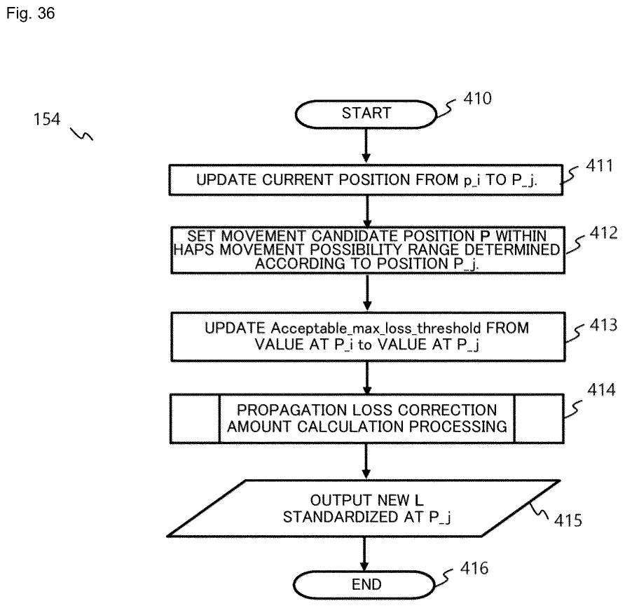

FIG. 36 is a flowchart illustrating details of the post-movement parameter update processing in step 154 according to Embodiment 3 of the present disclosure.

In FIG. 36, steps 410 to 411 are the same as in Embodiment 1 described in FIG. 26. However, in FIG. 36, processing (step 412) for setting the movement candidate position P=(P_1, P_2, . . . , P_n) within the movement possibility range 431 corresponding to the new current position of the HAPS 101 is further included. Processing in step 413 and subsequent steps is the same as that in the example of FIG. 26.

As described above, the HAPS monitoring and control station 106 can update the parameters according to the movement possibility range 431 corresponding to the new current position of the HAPS 101.

As described above, in the wireless communication system 430 according to Embodiment 3 of the present disclosure, the movement possibility range 431 corresponding to the current position of the HAPS 101 is predetermined. When it is predicted that communication quality using the feeder link 111 cannot be ensured due to rainfall, the HAPS 101 is moved to a movement candidate position within the movement possibility range 431 corresponding to the current position of the HAPS 101. This makes it possible to ensure communication quality and realize improvement of the line operation rate.

### Comparison Between Embodiments 1 to 3

Here, the advantages and disadvantages of Embodiments 1 to 3 described above are compared.

First, in Embodiment 1, the movement possibility range 231 of the HAPS 101 is limited to a narrow range in advance, and an optimum position is searched in the limited range. In this case, the calculation such as the position movement processing (step 232) of the HAPS 101 is limited to within the movement possibility range 231 of the HAPS 101. A calculation scale is moderate in the embodiments of the present disclosure even though the calculation scale depends on a particle size of the calculation range.

The advantage of Embodiment 1 is that, since the HAPS continues to stay within the same range, an influence on the service link 110 is less. Further, when the HAPS 101 performs the inter-HAPS communication, there is an advantage that an influence on the inter-HAPS communication is small.

On the other hand, the disadvantage of Embodiment 1 is that, since the movement possibility range 231 of the HAPS 101 is narrowed, when the influence of rainfall cannot be avoided even when the HAPS 101 moves within the movement possibility range 231, the HAPS 101 must be given up early. Although the case of line disconnection due to rainfall is improved above the related art, it can be said that this is most frequent in the embodiments of the present disclosure.

Next, in Embodiment 2, the plurality of movement possibility positions 331 are fixedly set in the HAPS area 109, and an optimum position is selected on the basis of the communication quality prediction at each position. Since the movement possibility position 331 is determined in advance, the point to be calculated is fixed.

The advantage of Embodiment 2 is that the most rainfall operation rate can be obtained by sequentially selecting the movement positions to avoid the rainfall from the entire area of the HAPS area 109. Further, although the calculation scale depends on the number of movement possibility positions 331, the calculation scale can be minimized in the embodiments of the present disclosure.

On the other hand, a disadvantage of Embodiment 2 is that, since the movement possibility positions 331 are distributed in a wide range, the change in the position of the HAPS 101 may become rapid, and the influence on the HAPS area 109 or the inter-HAPS communication becomes large. For the same reason, it can be said that the change of the feeder link 111 becomes large.

Finally, in Embodiment 3, the movement possibility range 431 corresponding to the current position of the HAPS 101 is limited to a narrow range in advance, and an optimum position is searched among these. A range for performing calculation such as the position movement processing (step 232) of the HAPS 101 also varies according to the movement. It can be said that the calculation scale can be substantially the same as that of Embodiment 1 even though calculation scale depends on the particle size of the calculation range.

An advantage of Embodiment 3 is that the feeder link 111 is less likely to be disconnected and the line operation rate is high as compared with Embodiment 1. Since the amount of movement of the HAPS 101 per one time is small, it can be said that an influence on the service link 110 or the inter-HAPS communication is small.

On the other hand, in Embodiment 3, although the influence of rainfall cannot be avoided as a result, the HAPS 101 moves slowly but moves throughout the HAPS area 109. Therefore, it is a disadvantage that there is a possibility of having an influence on the service link 110 or the inter-HAPS communication.

### Embodiment 4

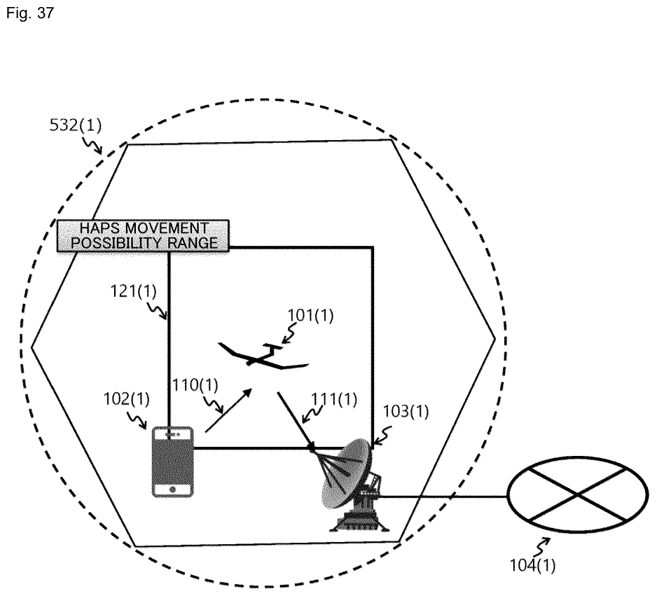

FIG. 37 is a diagram showing a configuration of one cell according to Embodiment 4 of the present disclosure. The cell is a wireless area covered by one HAPS. The cell 532(1) includes an HAPS 101(1), a terminal 102(1), an HAPS ground station 103(1), and a terrestrial network 104(1). Further, wireless communication using the service link 110(1) is performed between the HAPS 101(1) and the terminal 102(1). Further, wireless communication using the feeder link 111(1) is performed between the HAPS 101(1) and the HAPS ground station 103(1). Further, as illustrated in Embodiment 1, a movement possibility range 231(1) is determined in the HAPS 101 in advance.

In the embodiment, (n) is assigned to the end of the reference sign to indicate that the component is included in the n-th cell 532(n).

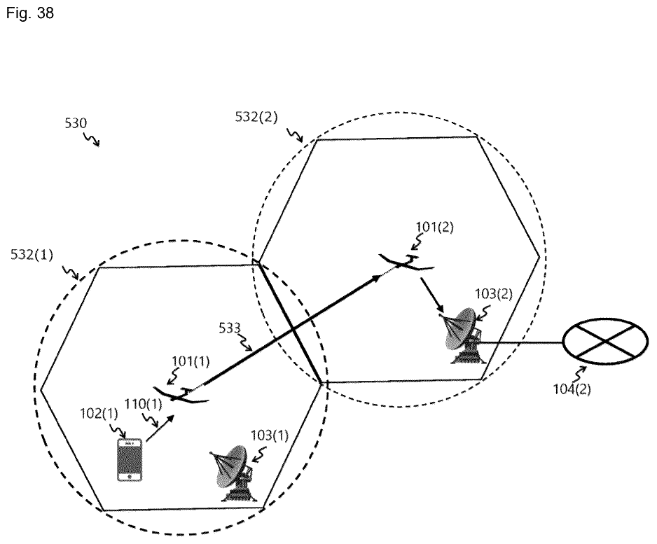

FIG. 38 is a diagram illustrating a configuration of a wireless communication system according to Embodiment 4 of the present disclosure. The wireless communication system 530 includes two adjacent cells 532(1) and 532(2). In the two cells 532(1) and 532(2), the inter-HAPS communication 533 can be performed between the HAPS 101(1) and the HAPS 101(2), and traffic in one cell can be transferred to the other.

For example, in the first cell 532(1), in a case in which the line disconnection due to rainfall cannot be avoided even when the HAPS (1) is moved to any place, rain does not fall in the adjacent cell 532(2). In such a case, the traffic of the cell 532(1) is transferred to the cell 532(2) by the inter-HAPS communication 533, and is made to reach the terrestrial network 104(2), whereby the line disconnection can be avoided.

As described above, in the wireless communication system 530 according to Embodiment 4 of the present disclosure, even when the movement position at which the influence of rainfall on the feeder link 111 can be avoided cannot be selected in one cell, the line operation rate can be improved by switching to the inter-HAPS communication 533.

Although the case in which the two cells 532 are adjacent to each other has been described in the present embodiment, a plurality of cells may be adjacent to each other.

Further, in the present embodiment, the case in which the movement possibility range 231(1) is previously determined in the HAPS 101 as in Embodiment 1 has been described. However, the plurality of movement possibility positions 331 may be determined as in Embodiment 2. Similarly, as in Embodiment 3, the movement possibility range 431 corresponding to the current position may be determined.

As described above, in the wireless communication system, the wireless relay station monitoring control device, and the wireless communication method of the present disclosure, even when there is the influence of the rainfall in the feeder link of the NTN, it is possible to ensure the communication quality and improve the operation rate of the NTN.

### REFERENCE SIGNS LIST

100, 230, 330, 430, 530 Wireless communication system
101 HAPS
102 Terminal
103 HAPS ground station
104 Ground Network
105 External network
106 HAPS monitoring and control station
107 HAPS control station
108 Monitoring control signal
109 HAPS area
110 Service link
111 Feeder link
112 Rain area
113 Point at which position of HAPS is projected onto ground surface
114 Solid line
115 Dotted line
231 Movement possibility range
331 Movement possibility position
431 Movement possibility range corresponding to current position
532 Cell
533 Inter-HAPS communication

1. A wireless communication system for performing communication using a non-terrestrial network, the wireless communication system comprising:
a wireless relay station configured to stay in the air and relay wireless communication;
a ground station configured to perform transmission and reception of radio waves to and from the wireless relay station and connect the wireless communication of the non-terrestrial network to a terrestrial network; and
a wireless relay station monitoring controller configured to monitor and control the wireless relay station and the ground station via the terrestrial network, wherein
the wireless relay station monitoring controller is configured to execute:
calculating a prediction value of a rainfall attenuation amount of the radio wave at a movement candidate position in a radio relay area of the wireless relay station and a current position on the basis of weather prediction information;
predicting communication quality due to the radio wave at the movement candidate position and the current position of the wireless relay station on the basis of the prediction value;
selecting a position at which attenuation of the radio wave is predicted to be less than that in which the wireless relay station stays at a current position from among the movement candidate positions on the basis of the communication quality; and
moving the wireless relay station to the position selected by the movement position selection.

2. The wireless communication system according to claim 1, wherein
a movement possibility range of the wireless relay station is defined in the wireless relay area, and
the wireless relay station monitoring controller determines the movement candidate position from the movement possibility range.

3. The wireless communication system according to claim 1, wherein
a plurality of movement possibility positions of the wireless relay stations are determined in the wireless relay area, and
the wireless relay station monitoring controller sets the plurality of movement possibility positions as the movement candidate positions.

4. The wireless communication system according to claim 2, wherein
the movement possibility range of the wireless relay station is determined according to a position in the wireless relay area.

5. The wireless communication system according to claim 1, wherein
the weather prediction information is information of a precipitation intensity prediction value given for each area obtained by dividing the ground into a lattice shape, and
the wireless relay station monitoring controller is configured to execute, in the calculation of the prediction value of a rainfall attenuation amount:
extracting the lattice-shaped area for a propagation section of the radio wave propagating in a range from a ground surface to an upper limit of a height of the rain area;
acquiring a precipitation intensity prediction value in the extracted lattice-shaped area;
converting the acquired precipitation intensity prediction value into a rainfall attenuation coefficient;
calculating a propagation distance of the radio wave for each of the extracted lattice-shaped areas; and
calculating a prediction value of the rainfall attenuation amount of the radio wave on the basis of the rainfall attenuation coefficient and the propagation distance of the radio wave.

6. The wireless communication system according to claim 1, wherein
the wireless relay station monitoring controller uses a prediction value of the rainfall attenuation amount of the radio wave, a threshold of an allowable maximum attenuation amount of the radio wave, and a propagation loss at the movement candidate position with a propagation loss at the current position of the wireless relay station as a reference to predict whether or not the communication line using the radio wave will be disconnected at the current position and the movement candidate position in the prediction of communication quality,
selects a position at which line disconnection is predicted not to occur from among the movement candidate positions in the movement position selection when it is predicted that the line disconnection occurs at the current position, and
moves the wireless relay station to the position selected in the movement position selection.

7. A wireless relay station monitoring controller for monitoring and controlling a wireless relay station staying in the air in a non-ground network, wherein the wireless relay station monitoring controller is configured to execute:
calculating a prediction value of a rainfall attenuation amount at a movement candidate position and a current position in a radio relay area of the wireless relay station on the basis of weather prediction information, for a radio wave transmitted and received between the wireless relay station and a ground station;
predicting communication quality due to the radio wave at the movement candidate position and the current position of the wireless relay station on the basis of the prediction value;
selecting a position at which attenuation of the radio wave is predicted to be less than that in which the wireless relay station stays at a current position from among the movement candidate positions on the basis of the communication quality; and
moving the wireless relay station to the position selected by the movement position selection.

8. A wireless communication method for performing communication using a non-ground network, the wireless communication method comprising;
causing a wireless relay station staying in the air to relay wireless communication in an area,
causing a ground station configured to transmit and receive radio waves to and from the wireless relay station to connect wireless communication of the non-ground network to a ground network, and
causing a wireless relay station monitoring controller for monitoring and controlling the wireless relay station and the ground station via the ground network to execute:
calculating a prediction value of a rainfall attenuation amount of the radio wave at a movement candidate position in a radio relay area of the wireless relay station and a current position on the basis of weather prediction information;
predicting communication quality due to the radio wave at the movement candidate position and the current position of the wireless relay station on the basis of the prediction value;
selecting a position at which attenuation of the radio wave is predicted to be less than that in which the wireless relay station stays at a current position from among the movement candidate positions on the basis of the communication quality; and
moving the wireless relay station to the position selected by the movement position selection.
